(19) United States
(12) Patent Application Publication
(10) Pub. No.: US 2015/0379488 A1
(43) Pub. Date: Dec. 31, 2015

(54) AUTOMATED PROACTIVE ELECTRONIC RESOURCE ALLOCATION PROCESSING SYSTEM

(71) Applicant: CLEAR PATH FINANCIAL, Springville, UT (US)

(72) Inventors: Lawrence H. Ruff, Springville, UT (US); Ryan L. Ruff, Springville, UT (US); Ronald B. Hammond, American Fork, UT (US); Jaron S. Glenn, Provo, UT (US)

(73) Assignee: Clear Path Financial, Springville, UT (US)

(21) Appl. No.: 14/749,369

(22) Filed: Jun. 24, 2015

Related U.S. Application Data
(60) Provisional application No. 62/018,257, filed on Jun. 27, 2014.

(51) Int. Cl. G06Q 20/10; G06Q 40/06; G06Q 20/38

(52) U.S. Cl. CPC G06Q 20/108; G06Q 20/38; G06Q 20/102; G06Q 40/06

(57) ABSTRACT

An automated proactive electronic resource allocation processing system can allocate resources based at least in part on configuration information. In one embodiment, a processing system can determine a strategic configuration of user accounts (“Accounts”) based on information collected about a user. One or more computing resources can communicate, such as over a network, to configure a plurality of Account features, attributes, identities, permissions, controls, and/or restrictions for each Account in order to accomplish objectives related to the resources. One or more computing resources can be configured to proactively and automatically allocate resources to one or more user Accounts. A computing resource associated with a user Account can be configured to complete a plurality of desired or necessary transactions, including receiving, holding, and reporting current balance information, and/or transferring portions of the financial resources to other user Accounts or other non-user accounts.

### RELATED APPLICATION

This application claims the benefit under 35 U.S.C. §119(e) of U.S. Provisional Application No. 62/018,257 filed Jun. 27, 2014, which is incorporated by reference herein in its entirety.

### TECHNICAL FIELD

The present disclosure relates generally to systems for automated electronic resource allocation including generation, maintenance and use of data, records and/or transactions.

### BRIEF DESCRIPTION OF THE DRAWINGS

FIG. 1 is a schematic diagram illustrating an automated proactive electronic resource allocation processing system consistent with embodiments disclosed herein.

FIG. 2 is a schematic diagram illustrating a user interface computing system consistent with embodiments disclosed herein.

FIG. 3 is a schematic diagram of a processing system consistent with embodiments disclosed herein.

FIG. 4 is a schematic diagram of an account system consistent with embodiments disclosed herein.

FIG. 5 is a schematic diagram of an alternative account system consistent with embodiments disclosed herein.

FIG. 6 is schematic diagram of systems that enable a debit card with dynamic account selection consistent with embodiments disclosed herein.

FIG. 7 is a diagram of a network service supporting the automated proactive electronic resource allocation processing system consistent with embodiments disclosed herein.

FIG. 8 is a flow chart illustrating a method for proactive electronic resource allocation consistent with embodiments disclosed herein.

FIG. 9 is a schematic diagram of a computing system consistent with embodiments disclosed herein.

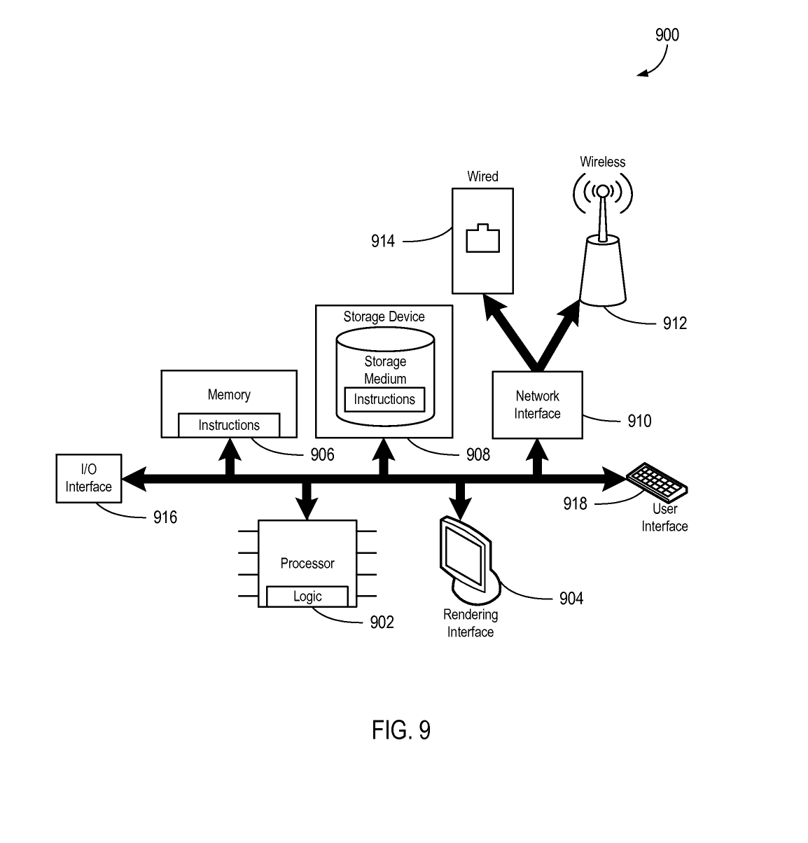

### BACKGROUND

Some finance gurus suggest a way to master finances is to pay (or allocate financial resources to) oneself first. Starting young and setting aside or allocating at least 10% of income into a 401(k) retirement plan before other spending are suggestions to establish financial security and/or prepare for retirement. However, without control over other spending decisions, a person can be adding debt at the same time that he or she is allocating resources to saving or investing. One can be paying more in interest charges than receiving returns on savings or investments.

Many people try to avoid credit card debt, but despite their intentions arrive at a position where using a credit card seems like the only logical choice for paying certain expenses. Many people fail to prepare or plan for expenses that will be faced throughout the year. These expenses can include things such as tires, vehicle maintenance, vacations, and Christmas gifts, among others. Some expenses, such as medical and dental expenses, auto repairs, furnace repairs, or an unexpected trip for a family funeral, are unpredictable, or less predictable.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

An automated proactive electronic resource allocation processing system can allocate resources based at least in part on configuration information, thereby automating the process of allocating resources. In one embodiment a processing system can determine a strategic allocation of resources based on configuration information and data collected from a user about his or her habits and goals. One or more computing resources can communicate, such as over a network, to proactively and automatically allocate resources in order to complete necessary transactions involving the resources. In an embodiment, the allocation of resources may be in accordance with a predetermined plan or configuration instructions, as further defined below.

In one embodiment exists a user's financial plan. A user's financial plan, or strategy to obtain and maintain optimal overall financial health of the user, could include a balanced strategy to ensure sufficient resources are allocated and consumed on spending for the user's highest priorities, both in the short term and in the future. A user's financial plan could also include a balanced strategy for the paying off the user's debts, taking into account the safest and/or quickest way to pay off the user's debts, given the amount of resources allocated for paying off debt. Configuration instructions pertaining to how to implement a user's financial plan are created from configuration information and data collected about the user, including data on the user's habits and goals, among other data. A computing resource (e.g., computer processing system) associated with a user account is configured to transfer portions of the financial resources automatically to one or more other accounts, deemed “Transfer Accounts,” as more fully defined below. Computing resources associated with the Transfer Accounts can be configured to automatically transfer resources to a computing resource associated with a Master Transfer Account. The computing resources are configured to automatically allocate and transfer portions of the resources to computing resources that represent other accounts owned by the same user (deemed “internal accounts,” as more fully defined below). The computing resources can be configured to place restrictions on transfers to accounts not owned by the user (“external accounts”). Configuring the financial resources managed by the computing resources in this manner can protect the resources from unauthorized access or attempts to initiate external transfers to third parties.

In an embodiment applied to financial resources, one or more computing resources associated with a Master Transfer Account can be configured to further allocate and distribute financial resources to computing resources associated with a plurality of accounts. Some of the computing resources associated with the plurality of accounts can be configured with external transfer permissions. By limiting the computing resources with external transfer permissions to a smaller subset of transferred financial resources, the amount of financial resources at risk from external access can be reduced and/or mitigated.

In some embodiments, one or more computing resources associated with a Master Transfer Account can transfer portions of financial resources to computing resources configured to save or accumulate financial resources over time. The computing resources are configured to transfer portions of the financial resources only to other computing resources that are owned by and/or controlled by the same user. As the computing resources are restricted from external transfers, financial resources, as well as other private and/or personally identifiable user data managed by the computing resources, can be protected from external access and transfers. In order to make an external transfer, the computing resources associated with the asset accumulation can be required to first transfer financial resources to computing resources configured with external transfer permissions.

Some computing resources can be configured to limit external transfers to identified external computing resources. In one embodiment, a computing resource associated with an Account having external transfer permissions receives a pre-determined allocation of financial resources to further allocate and distribute among a plurality of external computing resources. Upon receiving the transfer of financial resources, the computing resource allocates the financial resources according to configuration instructions and causes the financial resources to be transferred externally (e.g., to a third-party computing resource configured to receive the financial resources). In some embodiments, financial resources that exceed a minimum amount required to satisfy external transfer minimum requirements are allocated by the computing resource to one or more external transfers according to a priority of the external transfer.

In an embodiment, a computing resource can determine and/or follow a schedule of transfers of financial resources between Accounts. The computing resource can identify and/or receive dates, such as via user input, on which transfers between computing resources and/or Accounts represented by the computing resources should occur. In some embodiments, third-party computing resources communicate expected transfer dates and/or amounts, which can be scheduled for transfer by the computing resource. In other embodiments, a user can provide transfer dates and/or other instructions.

The system can include Containers, a user Dashboard, a Behavioral Management Processing System, a Configuration Processing System, an Allocation Processing System, an Active Agent Processing System, Smart Payment Processing Systems, and a Master Relay Processing System.

Containers, or “Accounts,” can receive, hold, and allow the transfer of digital money or other financial resources based on configuration information, or “Configuration Instructions.”

A user Dashboard, or other reporting system, can report to the user the current available Account Balances or balance of resources available in the Containers. Account Balances are hard spending limits.

A Behavioral Management Processing System can i) establish an emotional attachment to the digital Containers, or Accounts, and ii) establish and implement default effective financial management actions.

A Configuration Processing System can (in conjunction with a Set Up Wizard) provide the user with simple, streamlined initial set up, configuration, and implementation of the Containers, or Accounts, as well as ongoing updates and changes to the Configuration Instructions.

An Allocation Processing System can provide automated allocation of financial resources to the Accounts.

An Active Agent Processing System can learn and apply knowledge gained from user transactions and other available information.

Smart Payment Processing Systems can automate and add intelligence to making payments and other transfers to assist various activities of the user, depending on his or her financial resources and needs.

A Master Relay Processing System can communicate configuration information between processing systems and the Containers.

Additional aspects and advantages will be apparent from the following detailed description of preferred embodiments, which proceeds with reference to the accompanying drawings.

An automated proactive electronic resource allocation processing system can allocate resources based at least in part on configuration information. In one embodiment, a group of processing systems can determine a strategic allocation of financial resources based on configuration information, data collected from the customer about the user's spending habits and financial goals, data collected from other user sources such as user External Data, and external data collected from various external sources. One or more computing resources can communicate, such as over a network, to allocate financial resources in order to settle or complete a transaction involving the financial resources.

For example, computing resources can represent a plurality of bank and other financial accounts such as checking accounts, savings accounts, prepaid accounts, and investment accounts, among other types of accounts. Computing resources can also represent a plurality of accounts configured with new types of restrictions, limitations, permissions, or features to accomplish a plurality of innovative functions as outlined herein.

While the disclosure may describe systems, instructions, and configurations in terms of accounts, it should be recognized that accounts can be implemented by one or more computing resources in communication over a network. These computing resources can store and communicate account data, metadata, and configurations using data structures (e.g., tables, files, etc.). These computing resources representing Accounts can also be linked to and communicate with external resources and computing systems to accomplish the assigned configurations and/or instructions.

While the disclosure may use terms such as financial resources, income, and money, it should be recognized that the financial resources, income, and money, as used herein, are data (or are represented by data), which can be stored in data structures by the computing systems. Said data can constitute, or represent ownership of, money or other financial resources of recognized value, because of the established, accepted, and recognized attributes of said data and the related data frameworks, structures, rules, and systems. Said attributes can be established and recognized among central monetary authorities, among financial or other institutions, or among certain communities of users. For example, transfers of money can be accomplished by a first computing system electronically communicating money data from a first local data store to a second computing system which stores the money data in a second data store.

A consumer, or “user” of the systems, may establish and be the owner of resources in financial accounts that are encompassed within the systems (herein termed “internal accounts,” or simply “Accounts”). In an embodiment, a user may also be the owner of resources in financial accounts that are not encompassed within the systems (herein termed “external accounts”). As used herein, Accounts are bank accounts or other financial accounts that receive deposits of, hold, and allow withdrawals and transfers of money, or other financial resources, based on the account terms and conditions, configuration, and/or instructions of the account owner. Accounts can be separate, individual, compartmentalized financial accounts established with and held at account provider financial or other institutions. Accounts can be held by and maintained within the same financial institution or at different financial institutions or non-financial institutions.

Accounts can be traditional bank accounts (checking, savings, deposit, transactional, demand, sweep, demand deposit, NOW account, brokerage, money market, certificate of deposit, other investment, etc.) or new types of bank accounts, or can be accounts at non-bank financial institutions or even other non-financial institutions. Accounts can have customized configuration features, attributes, and rules, including such as overdraft protection, transfer limits, and other traditional bank restrictions, limitations, or allowances. Accounts can also have rules, restrictions, limitations, permissions, or attributes not commonly associated with traditional bank accounts. Accounts can be debit card, credit card, prepaid spending card, re-loadable card, gift card, smart card, rewards card, loyalty card, or other types of bank card or card network related accounts. Accounts can be prepaid balances with mobile phone companies, airtime remittance companies, or other companies supporting receiving, holding, and transfers of financial resources. Accounts can be digital or computer “wallets,” payment accounts, or payment devices where digital or virtual currencies are stored.

In some embodiments, Accounts do not include sub-accounts. Each Account can be a separate, compartmentalized account, with no transfer or other relationship to any other accounts except as established and controlled by the system. This requirement creates a closed loop system, which allows the system to more fully manage and control account access, authentication, security, current balance and other reporting, and other functions of the system. While the advent of mobile computing and other certain technologies are essential to the effective implementation of the system, they introduce new and increase existing threats of security and privacy breaches. Compartmentalization of Accounts, combined with the closed loop nature of the system, can mitigate this increased threat.

In other embodiments, Accounts do not include virtual, simulated, or knowledge representations of bank accounts or other types of accounts. In some embodiments, Accounts do not include sub-accounts, or any similar accounts that are not subject to control by the system, or accounts that are subject to control by more than one processing system. Such accounts can introduce the need to reconcile between the various systems. The need for reconciliation can result in additional user work to maintain the simulated or virtual accounts and/or systems. The need for reconciliation can also result in the lack of transparency and/or accuracy and timeliness in reporting current balance information to the user(s) at the point in time that spending decisions take place. The need for reconciliation, and the resultant lack of transparency and timeliness of current balance information, can be problematic when an account has more than one owner, such as a joint account. In an embodiment, manual check writing can also be restricted for similar reasons.

In an embodiment, Accounts can have “identities” that can include identifying account numbers, routing numbers, names, access codes, and other identifying and configuration information associated with the account plus additional “profile” identifying information associated with each account. Profile information can include the source(s) of financial resources for income accounts and the category for category savings or spending accounts, contact information for account owner, communication preferences, etc. Contact information can include physical mailing address and email address such that billing and payment information can be sent or forwarded specifically to each account. Each account can have one or more identities associated with the account, and each identity can have different rules, restrictions, limitations, permissions, or attributes associated with the account (e.g., view only access versus transfer access). Each account can have one or more owners associated with the account, and each owner can have different rules, restrictions, limitations, permissions, or attributes associated with the account (e.g., view only access versus transfer access). Accounts can have single- or multi-signature access control, authentication, authorization, and permission configurations, typically for each of the individual account identities and for each of the individual account owners.

Money, as used herein, can be any system of transferable value or credit, including as governed by a central bank or other monetary authority, or community accepted algorithm or framework. Money can include electronic money, mobile money, mobile payments, digital currencies, crypto-currencies, and virtual currencies. Financial resources can include more than money, such as stocks, bonds, credits, tokens, invoices, bills, wills, trusts, and other financial instruments, both real and virtual.

In one embodiment, The Money Pool System™ is a proactive automated electronic money allocation system that uses multiple Accounts, as defined below. Each separate category of a person's financial matters is represented by a, or assigned to its own separate, compartmentalized Account in a one-to-one relationship. Each Account is named for its intended purpose, so as to foster an emotional attachment. The Money Pool System™ uses new types of Accounts and new types of computer processing systems with new features and controls, which combine to provide additional features and functionality, additional layers of security, and additional help and convenience to the user in managing his or her financial matters. The following includes a description of example types of Accounts used in The Money Pool System™.

Income Accounts: An Income Account receives money from external income sources, e.g., through automatic deposit. Each Income Account can be configured to receive income from multiple sources or only one source according to user preferences. This allows for an easy accounting of income over time. For fraud protection, these Accounts are configured to automatically transfer their funds as soon as they receive them into a more secure Master Transfer Account.

Incoming Transfers Accounts: These Accounts are set up and configured for the receipt of incoming transfers of money or other resources not considered income such as borrowed money, money transfers from external accounts, or other sources. Each Incoming Transfers Account can be configured to receive incoming transfers from multiple sources or only one source according to user preferences. Each Incoming Transfers Account can be designed and configured to only be able to transfer money internally to Accounts within the Accounts Configuration so as to limit the exposure of user's money to certain types of fraud. For fraud protection, these Accounts can also automatically transfer their funds as soon as they receive them into a more secure Master Transfer Account.

Income Accounts and Incoming Transfers Accounts can be further protected by restricting them from being able to make any payments or external transfers, limiting them to the ability to receive funds from external sources and to transfer funds to internal accounts. For example, if a hacker was able to get into an employer's direct deposit records and find out the user's Income Account account number, it may do him little good because it can prohibit payments or transfers to outside accounts or any external party.

Transfer Accounts: Transfer Accounts are Accounts that receive money from Income Accounts and Incoming Transfers Accounts and transfer money to other internal Spending Accounts, Savings Accounts, and other Accounts. Transfer Accounts can also be configured to be more secure or Safe Accounts (i.e., having an additional layer of security) by restricting them from allowing any outside payments, withdrawals, or outside transfers. Transfer Accounts are also further protected in that a user does not need to give out account numbers or other identifying information to third parties for Transfer Accounts. Since a user never spends from these Accounts, he or she has no debit cards issued to or associated with him or her. He or she is protected from the fraud that occurs from data breaches where a hacker gains access to the debit cards and/or bank account numbers that a user may give out to merchants from whom he or she made purchases.

Master Transfer Account: The Money Pool System™ revolves around an Account dedicated to facilitating internal transfers between Accounts, within the Accounts Configuration, called a Master Transfer Account. It is configured to automatically receive the money from Income Accounts or “Incoming Transfers Accounts” and automatically allocate and distribute allowances (which can be weekly) to each of various types of Category Savings Accounts, Category Spending Accounts, Automated Debt Payment Accounts, Automated Bill Payment Accounts, and External Transfers Accounts. Once allocations have been made and other linked Accounts have been funded, the Master Transfer Account can retain any money that is left over as a general reserve or growing emergency fund, or the user can periodically make other decisions regarding its disposition.

Savings Accounts: Category Savings Accounts are used to accumulate funds to pay for expenses that happen intermittently throughout the year such as Christmas presents, vacations, and auto repairs. These Accounts each receive allocations and transfers of money (which can be weekly, or other period) from the Master Transfer Account. Each category of financial spending that is meaningful to a user should be assigned to its very own Account, either a Category Savings Account or a Category Spending Account (as described below). Category Savings Accounts can be set up and configured for each distinct short-term savings purpose or for each longer term savings goal. Examples include things such as emergency savings, college funds, auto replacement, etc. Money that a user wants to save for retirement can be automatically transferred to a Category Savings Account established for that purpose, right off the top before the user even sees it, just like taxes. This is beneficial from a behavior management perspective as the money allocated to this Account may not be as missed by the user. Category Savings Accounts are typically configured as Safe Accounts where a user will never need to provide the account numbers to any external third party. These Accounts are restricted from allowing any external payments or outside transfers. When a user wishes to make a payment from a Category Savings Account, the user can first transfer money from a miscellaneous spending account as described below.

Spending Accounts: There are several different specialized kinds of Spending Accounts used with The Money Pool System™ that include Category Spending Accounts, miscellaneous spending accounts, Automated Debt Payment Accounts, Automated Bill Payment Accounts, and External Transfers Accounts. Category Spending Accounts are configured to allow the user to spend and make payments to third parties for goods or services, or other external transfers of money. Spending Accounts receive their allocations (which can be weekly) from the Master Transfer Account. Because the user can initiate external transactions from these Accounts such as electronic payments and debit card purchases, they are not considered Safe Accounts. Risk of loss is mitigated because each Account holds only that amount of money that has been allocated for a specific purpose, and for a relatively short period of time. Therefore, risk of financial loss is far lower than the risk of loss that results from using only one traditional bank account where all of a consumer's available funds may be held. A user can easily, and will quickly learn to, check the available account balance to know how much of his or her periodic allocation remains available for spending in the appropriate Category Spending Account before he or she spends. In one embodiment, the user is not able to spend more money than the balance the user has remaining in that Category Spending Account without first transferring additional money into that Account. To transfer money into that Category Spending Account, the user is required to choose which other Account to transfer funds (“steal” or “borrow”) from. Money transferred from other Accounts can be transferred manually by the user or money can be transferred automatically according to programmed logic and/or user pre-authorization as may be implemented in other embodiments. In an embodiment, transfers into and out of a Spending Account are reflected in the current account balance instantaneously or approximately at the same time as the transfer (such as within seconds or minutes). In such embodiment, the Spending Account can be restricted from manual check writing or any other delayed form of deposit or drafting, such that reconciliation of the Spending Account for outstanding checks or deposits in transit is not required. In an embodiment, transfers to the Spending Account can be restricted solely to allocations by the system from the Master Transfer Account, and not subject to delays or “holds” on the funds transferred. In an embodiment, payments or transfers out of the Spending Account that do not settle immediately may be permitted, and the amount of such payment or transfer can be deducted from the current available balance.

miscellaneous spending accounts: These Accounts are configured to allow the user to make payments to third parties for goods or services, utilizing funds transferred from Savings and/or Spending Accounts. These Accounts are linked to a payment device such as a debit card, checks, mobile payment, keychain dongle, or other type of payment device to facilitate spending. These Accounts can be linked internally to one or a plurality of Savings and/or Spending Accounts in such a manner as to facilitate the transfer of money into the miscellaneous spending account in order to carry out user spending. This can allow the user to spend out of various Savings and/or Spending Accounts via the use of a single payment device, thereby eliminating the need for the user to carry a separate payment device for spending out of each separate Account. Typically a user will have only one miscellaneous spending account. When a user wishes to make a purchase from a Category Savings Account or a Category Spending Account, the user can first transfer money from the appropriate Account into the miscellaneous spending account, and then spend by using the debit card, or other payment device, attached to this Account.

Automated Debt Payment Account: This Spending Account receives a periodic allocation and can use an automatic bill-payment service to make payments on mortgage, auto loans, student loans, credit cards, and any other debt. If a user has multiple debts, it can shorten the time it takes to pay off the debts by following an automated debt roll down strategy that applies any available extra principal payment toward a targeted debt. As each debt is paid off, instructions received from the processing systems can automatically increase the extra principal payment to the next targeted debt, until all debts are fully paid off. Additionally, through use of an “Aggregation Service” (a service that seeks out and gathers information about a user's bills and/or debts including balance, interest rate, payment, etc.) or the use of e-bills or electronic statements, it can save the user time and speed up the payoff of debts even more. The Aggregation Service or e-bills or electronic statements allow the processing system associated with the Automated Debt Payment Account to automatically know (e.g., receive information through an API (application programming interface) or contact third-party services through an API) and make the minimum monthly payment for each debt. This frees up the maximum amount of the total periodic allocation to be applied toward extra principal payments for the targeted debt. Once the automated debt roll down strategy is set up and configured in the processing systems, the strategy can be carried out automatically without any user input.

Automated Bill Payment Account: This Spending Account receives its allocation and can use auto bill pay to pay regular monthly bills such as utilities, Internet, phone, cable, subscriptions, etc. This Account can also take advantage of an aggregation service or e-bills or electronic statements that allows it to automatically know (e.g., receive information through an API or contact third-party services through an API) and make the monthly payment of monthly bills without user intervention. It can send the user automatic text notifications if a bill payment exceeds expected variations.

Funding Schedules are established as part of The Money Pool System™ that instructs the Master Transfer Account to automatically transfer predetermined allowances into other Accounts. These transfers usually happen weekly to coincide with the most easily managed spending period. Funding schedules can also specify minimum balances or other parameters related to the Accounts.

Once The Money Pool System™ has been set up and configured, the ongoing tasks required to effectively manage money and exercise control over spending can happen automatically. The Money Pool System™ can automatically follow through with the configured financial plan.

In addition, since spending categories are each implemented by establishing actual Accounts, a user can always see how much money is available to spend in each category, simply by checking its Account balance. In some embodiments, the Account balance is a hard spending limit, meaning the user is not permitted to spend more than the money available in the Account. If the Account balance is not sufficient at the time of payment initiation, then payment is not allowed/made, unless/until the available balance first becomes sufficient.

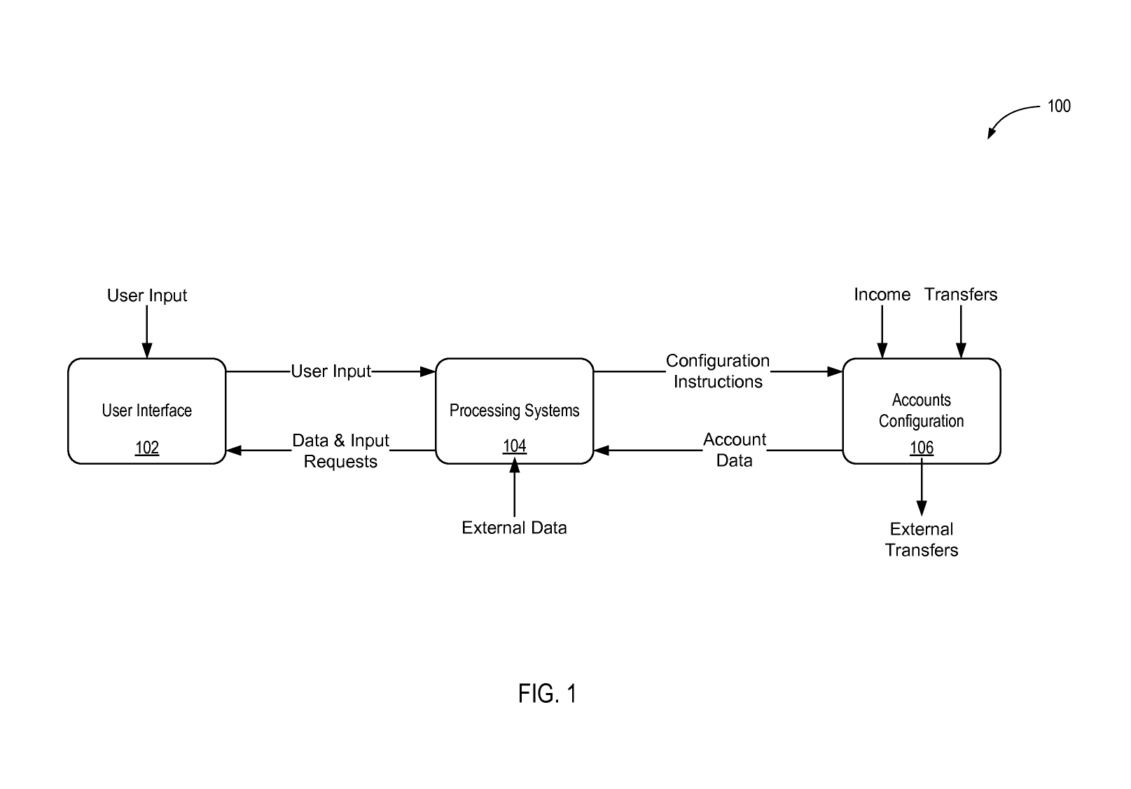

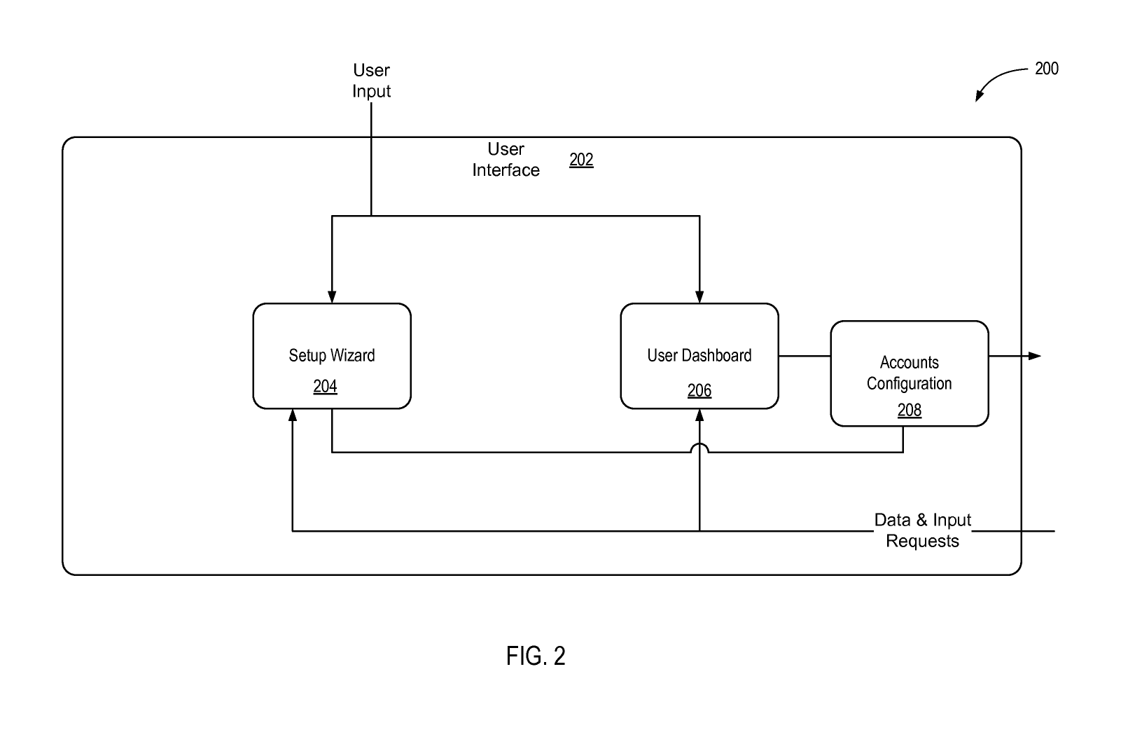

FIG. 1 illustrates how a user Interface 102, Processing Systems 104, and an Accounts Configuration 106 can be used in accordance with one embodiment. These systems can be composed of one or more computing resources, such as servers, databases, virtual machines, and/or storage systems. In this embodiment, the user accesses the user Interface 102 (described in more detail in FIG. 2) through an electronic device. The user answers a series of survey questions, illustrated here as user Input, that establish a knowledge base about the user including information such as, but not limited to: the user's identity, the user's personality, the user's financial perspective and priorities, the user's hobbies and interests, the user's financial goals and objectives, the user's income and projected expenses, and/or the user's assets and liabilities.

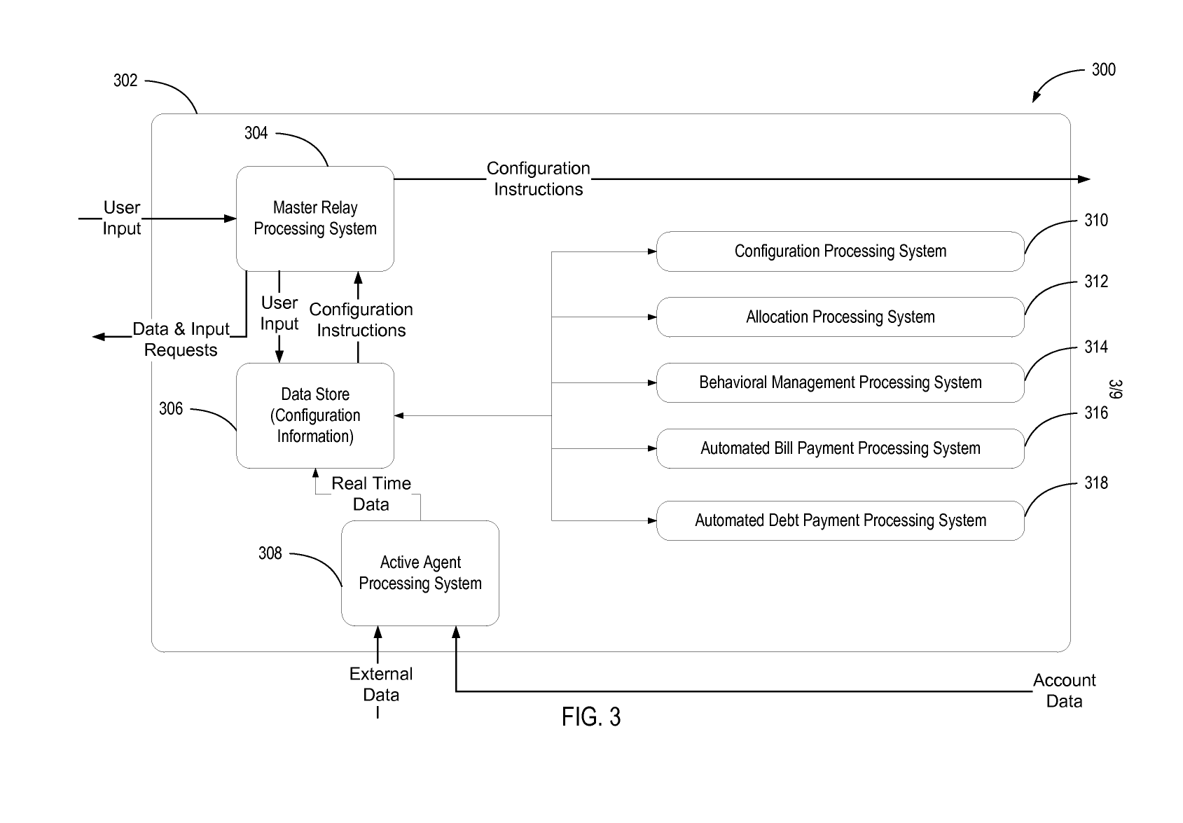

The user Input is sent to the Processing Systems 104 (described in more detail in FIG. 3). In the Processing Systems 104, the user Input is analyzed along with other gathered information such as Account Data and External Data. Through processing and analyzing the aforementioned data, the Processing Systems 104 can automatically create a set of Account Configuration Instructions, defined more fully below. A portion or all of the Account Configuration Instructions can then be sent, as Data & Input Requests, from the Processing Systems 104 to the user Interface 102 for the user to approve, modify, and/or reject. Configuration Instructions can include, but would not be limited to: how many and what types of Accounts to establish, for what purpose or category each Account should be used, what to name each Account, personalization items to attach to each Account (photos, themes, music), and/or how much, how often, and from what sources each Account should be funded.

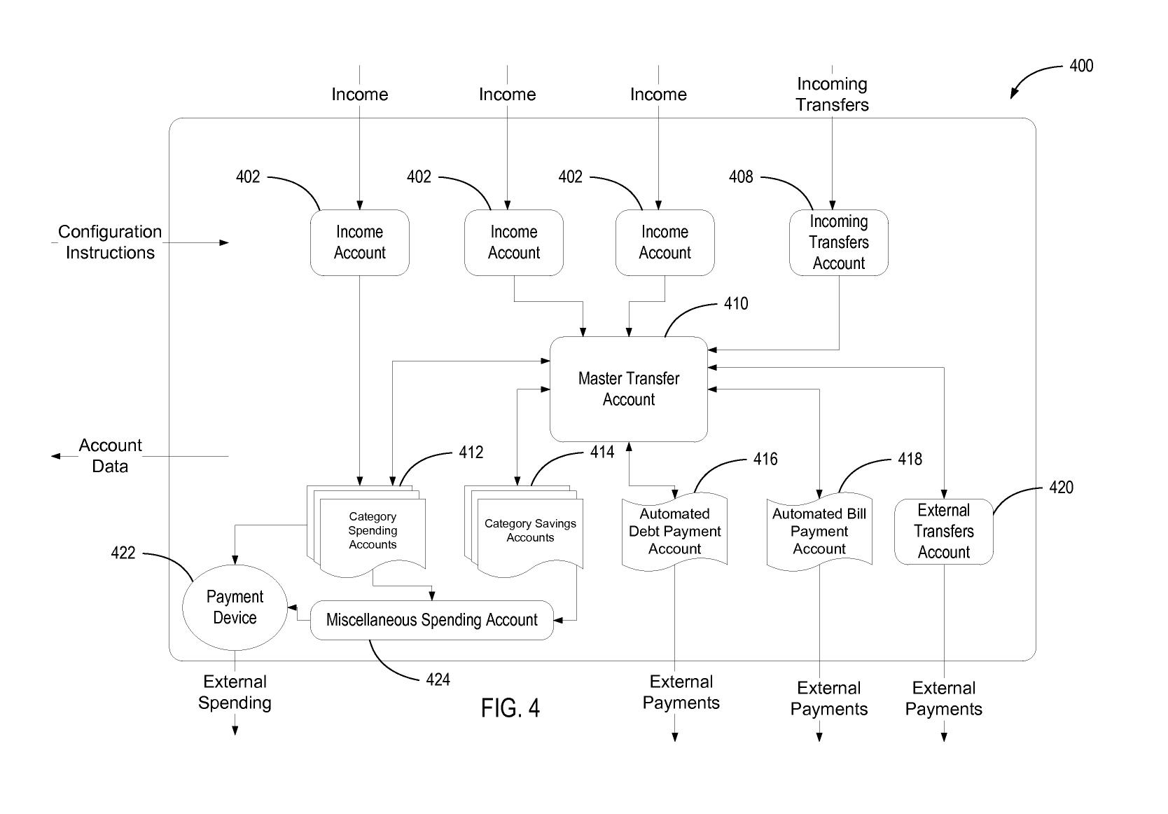

The approved, modified, and/or rejected Configuration Instructions are then sent to the Processing Systems 104 as revised user Input. Once approved, Configuration Instructions received by the Processing Systems 104 are relayed to the user's Accounts Configuration 106 (described in more detail in FIG. 4) as approved Configuration Instructions to be automatically implemented. Money, in the form of Income or Incoming Transfers of money from other external sources, can be deposited into one of the user's Accounts that exist within the user's Accounts Configuration 106. user spending, payments, and transfers to external accounts or external third parties are referred to in this illustration as External Transfers. As new deposits are made, money is transferred, payments are made, user spending occurs, or any other changes are made to the user's Accounts, this updated information is relayed to the Processing Systems 104 in the form of Account Data.

FIG. 2. illustrates a detailed view 200 of the user Interface 202 in the aforementioned embodiment. In the embodiment shown, elements of the user Interface 202 illustrated are a Setup Wizard 204, a user Dashboard 206, and an Account Configuration 208.

The Setup Wizard 204 is a user interactive software program that can interface with the processing systems and with minimal user effort, automatically complete complicated and time-consuming tasks for the user that are necessary for managing money. The user initially begins use of the Setup Wizard 204 by completing a survey, contained within the Setup Wizard 204. The survey solicits information about the user in order to establish a knowledge base about the user. The user may be asked questions in the survey that are related to subjects such as, but not limited to: the user's identity, the user's financial priorities, the user's hobbies and interests, the user's financial goals and objectives, the user's income and projected expenses, and/or the user's assets and liabilities.

Information gathered from the user in the survey is sent to the Processing Systems as user Input, where it is analyzed to create Configuration Instructions. Configuration Instructions can include, but would not be limited to: recommendations as to what bank accounts or prepaid debit card accounts to establish, an allocation amount for each account, an allocation schedule for each account, and/or nicknames to give each account.

The Configuration Instructions are then sent to the Setup Wizard 204 in the form of Data & Input Requests for the user to view, edit, reject, and/or approve each of the Configuration Instructions. The modified and/or approved Configuration Instructions are then sent to the Processing Systems as user Input to be implemented at the financial institution. In some embodiments, the Setup Wizard 204 is included internally and integrated within the financial institution's computer systems. In other embodiments, the Setup Wizard 204 is located external to financial institutions and configuration instructions are transmitted to a financial institution via an API.

The user Dashboard 206: After the initial setup has been completed, the user rarely has a need to continue to use the Setup Wizard 204. Future notifications of recommended Configuration Instructions created by the Processing Systems are sent to the user Dashboard 206 as Data & Input Requests to await user modification or approval. The user can utilize the user Dashboard 206 on an ongoing basis to access and view information about, and interact with, the user's Accounts and/or Accounts Configuration 208. Any modifications made by the user through the user Dashboard 206 are sent to the Processing Systems as user Input. Through the user Dashboard 206 the user can have the ability to do multiple actions.

These actions can include view Account details, including current Account balance, transaction history, pending transfers, and account attachments (nicknames, photos, themes, backgrounds, music, etc.); approve, edit, or reject recommended changes to Configuration Instructions generated by the Processing Systems; make user-initiated edits to the Accounts and/or Account settings such as deleting or creating new Accounts or modifying existing or creating new one-time or recurring transfers; initiate or stop payments; change the Account to which a user's payment device is linked for spending; change account names and/or features, or modify other settings; or view reports such as spending reports, assets and liabilities, etc.

FIG. 3 illustrates a detailed view 300 of an embodiment of the Processing Systems 302 as shown in FIG. 1. A Master Relay Processing System 304 can receive data from several different sources and relay the information to an intended destination. The Master Relay Processing System 304 includes account management logic coupled with and configured to manage a plurality of Accounts. The account management logic includes the required Account creation and configuration logic, transaction processing logic, and program instructions configured to receive transaction instructions, and i) process transactions for the Accounts and/or ii) relay instructions to other appropriate processing systems which process transactions for the Accounts. The account management logic is configured to store account data related to transactions and other Accounts management functions in a Data Store 306.

In one embodiment, the Processing Systems and Accounts in the Account Configuration are hosted by or provided by a single financial institution, of which the user is a customer. In other embodiments, Accounts may be provided by or hosted by more than one financial or other institution. The Processing Systems may be hosted by one of the institutions providing Accounts, or another institution. Where Accounts are hosted by an institution other than the institution hosting the Processing Systems, then the Master Relay Processing System 304 is configured to interface with, communicate account management and transaction instructions to, and receive account data from the account management processing systems of the Account hosting institution.

In one embodiment, in order for an account to qualify as an Account within the system of the implemented embodiment, the account and its related processing systems and hosting institution is able to, and can follow, account configuration, management, processing, and reporting instructions from the Processing Systems of the implemented embodiments.

user Input received from the user Interface can be relayed through the Master Relay Processing System 304 and routed to the Data Store 306. The Data Store 306 stores data received from multiple sources. The data stored in the Data Store 306 is always kept up to date as it continually receives new updated data in the form of user Input originating from the user Interface and Real Time Data from an Active Agent Processing System 308.

In one embodiment, the Active Agent Processing System 308 is an automated processing system that is continuously searching out and compiling Account Data (information about the user's Accounts such as current account balance, pending transactions, pending transfers to and from the Account, cleared transaction history, balance history, and other relevant information about the user's Accounts) and External Data (information originating from various external sources that can affect the user's finances and/or external data that can be of interest to the user such as e-statements or e-bills, benchmark spending data of the user's peers, coupons, sales, and the current price of popular consumer goods such as gas, milk, bread, etc.).

Several separate processing systems work together to automatically create, change, and/or update Configuration Instructions. These Processing Systems 302 can include: a Configuration Processing System 310, an Allocation Processing System 312, a Behavioral Management Processing System 314, an Automated Bill Payment Processing System 316, and/or an Automated Debt Payment Processing System 318.

In one embodiment, the aforementioned Processing Systems 302 can access archived information in the Data Store 306. Based off the received data and programmed logic, each processing system can create, modify, and/or update an executable set of Configuration Instructions and send them to the Data Store 306 as Configuration Instructions. The Configuration Instructions in the Data Store 306 are sent to the Master Relay Processing System 304 as Configuration Instructions. Configuration Instructions requiring approval by the user are relayed to the user Interface, as Data & Input Requests, in order to be approved. Pre-approved and Configuration Instructions manually approved by the user can be automatically implemented. In an embodiment where Processing Systems and Accounts in the Account Configuration are hosted by or provided by a single financial institution, of which the user is a customer, the Configuration Instructions can be automatically implemented by the Master Relay Processing System 304. In an embodiment where Accounts may be provided by or hosted by more than one financial or other institution, then the Master Relay Processing System 304 is configured to interface with and communicate account management and Configuration Instructions to the Account-hosting institution.

The Configuration Processing System 310 can be configured to create an executable set of Configuration Instructions regarding:
1) Number of Accounts to establish
2) Attributes of the Accounts including:
   a) Identifying account numbers
   b) Names
   c) Access codes and other identifying and configuration information
3) Identifying Information “Profile” associated with each Account
   a) (e.g., source of financial resources for income Accounts and category for category savings or spending Accounts)
   b) Identities associated with the Account
4) Levels of access to the Account for each identity (e.g., view only access versus transfer access)
5) Owners associated with the Account
6) Account Controls and access levels for each owner (i.e., view only access versus transfer access)
7) Account features including:
   a) Overdraft protection
   b) Transfer limits and other traditional bank restrictions
   c) Check writing and/or other payment capabilities
   d) Limitations or allowances
8) Where each Account within the Accounts Configuration should be hosted
9) Other configuration information

In one embodiment, the Allocation Processing System 312 is configured to create an executable set of Configuration Instructions as to how much and how often to fund each Account.

In another embodiment, the Behavioral Management Processing System 314 is configured to create an executable set of Configuration Instructions detailing how to foster a strong emotional connection between the user and the purpose for which each Account is intended to be used. For example, if an Account was established for the purpose of saving for the birthday of a child named John, the Behavioral Management Processing System 314 may create an executable set of instructions that instruct the Account to be named “John's Birthday!!!” with a picture of John attached to the Account and a background consisting of birthday-themed items such as birthday cakes and presents. The Behavioral Management Processing System 314 might instruct the creation or attachment of items to the user's Accounts such as, but not limited to: digital photographs, nicknames, backgrounds, themes, music, video clips, quotes, virtual pets, and other items.

In one embodiment, the Automated Bill Payment Processing System 316 is configured to create an executable set of Configuration Instructions to manage the setting up of and execution of the payments of the user's bills as they come due.

In one embodiment, the Automated Debt Payment Processing System 318 is configured to create an executable set of Configuration Instructions to manage the setting up of and execution of the payments of the user's debts as payments come due. The Automated Debt Payment Processing System 318 can also automatically adjust the payment amounts of the user's debts up or down so as to always pay at least the minimum payment due to each debt, but also to allocate any additional money available that was allocated to be paid toward debt, as an extra principal payment to a selected debt, thereby paying off the user's debts in a quick and efficient manner. The debt to receive the extra principal payment can be selected automatically by the processing system in accordance with well-known debt reduction strategies such as a debt roll down strategy.

FIG. 4 illustrates an Accounts Configuration 400 that can be established at the user's financial institution(s) in this embodiment. The Accounts existing within the Accounts Configuration 400 can be established, configured, personalized, managed, and/or closed manually by the user or automatically in accordance with received Configuration Instructions. Accounts can be classified by “Type” depending on the specific account configuration instructions.

Some Accounts share common fraud prevention attributes and are further classified as Safe Accounts. Safe Accounts have limitations on transfer privileges, and are generally configured to allow incoming and/or outgoing transfers only among other Accounts within the Accounts Configuration 400. Some Safe Accounts may be configured to receive external deposits or to make payments, but not both. This limited access and interaction with external accounts and external parties makes Safe Accounts more secure than traditional bank accounts that can be accessed by outside parties.

Accounts can be classified by functionality. Some general account classification types can be, but are not limited to:

Income Accounts 402 receive money derived from income sources. Each Income Account 402 can be configured to have the ability to receive Income from multiple sources or only one source according to user preferences and/or Configuration Instructions. Income Accounts 402 can be configured to be Safe Accounts that can only transfer money internally to other Accounts in the user's Accounts Configuration 400. In one embodiment, money transferred into an Income Account 402 would most often be transferred into the Master Transfer Account 410. In some embodiments, money can be transferred directly from an Income Account 402 to a Category Spending Account 412.

Incoming Transfers Accounts 408 receive incoming transfers of money or other resources not considered income such as loaned money, money from external accounts, or other sources. Each Incoming Transfers Account 408 can be configured to have the ability to receive incoming transfers from multiple sources or only one source according to user preferences and/or Configuration Instructions. Incoming Transfers Accounts 408 can be configured to be Safe Accounts. In one embodiment, money transferred into an Incoming Transfers Account 408 is transferred into the Master Transfer Account 410.

Master Transfer Accounts 410 facilitate the transfer of the user's money from Income Accounts 402 and Incoming Transfers Accounts 408 to Category Spending Accounts 412, Category Savings Accounts 414, Automated Debt Payment Accounts 416, Automated Bill Payment Accounts 418, External Transfers Accounts 420, or other Accounts. Master Transfer Accounts 410 can be configured to be Safe Accounts.

Category Spending Accounts 412 can be configured to facilitate user spending for a specific category. Category Spending Accounts 412 can be configured so that they can have an attached payment device such as a debit card, mobile payment, keychain dongle, or other type of payment device to facilitate spending. Category Spending Accounts 412 can be configured to restrict check writing and/or any other form of delayed transfers to or drafting from the Account. This restriction, combined with other Account features and restrictions, can eliminate the need for ongoing reconciliation of the Category Spending Accounts 412 for uncleared checks and deposits in transit, and enable the Account owner to more easily and confidently know the available balance remaining to spend in the Account. In an embodiment Category Spending Accounts 412 can be designed and configured so that they can be attached to a miscellaneous spending account 424.

Category Savings Accounts 414 can be configured to facilitate user savings for a specific category. Category Savings Accounts 414 can be configured to be Safe Accounts that can only receive or transfer money internally to other Accounts in the user's Account Configuration. Category Savings Accounts 414 can be designed and configured so that they can be attached to a miscellaneous spending account 424.

miscellaneous spending accounts 424 can be configured so that they have an attached payment device such as a debit card, checks, mobile payment, a keychain dongle, or other type of payment device to facilitate spending. miscellaneous spending accounts 424 can be configured to be linked to multiple Accounts in such a manner that it is easy for the user to manually transfer money or for the Processing Systems to automatically transfer money from Accounts into the miscellaneous spending account 424 in order to carry out user spending. This can allow the user to spend out of various user Accounts via the use of a single payment device, thereby eliminating the need for the user to have to carry on their person a separate payment device for spending out of each Account.

Automated Debt Payment Accounts 416 can be configured to facilitate the automatic payments of the user's various debts. Automated Debt Payment Accounts 416 can be configured to be Safe Accounts that can only receive money from internal accounts in the user's Account Configuration and only release money in the form of payments to a list of approved venders through which the user has an established debtor/creditor relationship.

Automated Bill Payment Accounts 418 can be configured to facilitate automatic payments of bills to various utility companies, vendors, or other types of organizations for services to which the user subscribes or for other types of recurring purchases. Automated Bill Payment Accounts 418 can be configured to be Safe Accounts that can only receive money from internal accounts in the user's Account Configuration and only release money in the form of payments to a list of approved venders through which the user has an established business account.

External Transfers Accounts 420 can be designed and configured to facilitate external transfers to other parties such as private parties, companies, lenders, or other types of external transfers that may not be considered spending or payments.

In one embodiment, a separate Income Account 402 can be set up and configured to receive deposits for each different source of income. By having each separate source of income assigned to a separate Income Account 402, The Money Pool System™ can easily identify and report on each source of income individually. These income reports can be used for a variety of important purposes such as financial forecasting, taxes, and other important purposes.

Income Accounts 402 are configured to be restricted in that they have the ability to receive transfers and/or deposits directly from external sources, but do not allow external transfers or withdrawals. Income Accounts 402 can also be configured to not have the ability to store money so that as money gets deposited into an Income Account 402, the money is instantly and automatically transferred out to another internal Account for more secure safekeeping. By designing and configuring Income Accounts 402 in such a manner, the user's exposure to potential monetary losses due to certain types of fraud is reduced.

This configuration can reduce the user's exposure to fraud involving instances where the user's personal account information is subject to a data breach of the user's employer's or other person, company, institution, or organization's information systems, from which a user receives income by direct deposit. With an Income Account 402, in such an instance, the account information belonging to the user that was compromised is the account information for a single Income Account 402. Because the user's Income Account 402 does not have money stored in it and because the Income Account 402 does not allow for external transactions or withdrawals, it reduces the user's exposure to monetary losses in the event of fraud in this type of situation.

In a category account set embodiment, a user may wish to easily identify all financial activity (for example, income, expense, current account balances) related to a particular category. For example, where a user has multiple sources of income, such as from a home-based business, rental properties, investments, etc., the user may wish to easily identify and report all activity related specifically to that business or source of income. This embodiment provides an easy way to accomplish that identification and reporting, without requiring separate or additional classification and tracking, by creating “sets” of Accounts consisting of one or more category income Accounts combined with one or more Category Spending Accounts 412 configured to accommodate receipt of income and spending associated with the designated category. To facilitate the setup and configuration of the Accounts for The Money Pool System™, the user need only designate or approve the recommendation of the various categories for which the user wishes a “set” of Accounts. In one embodiment, the category income and Category Spending Accounts 412 can be connected directly with each other to facilitate the transfer of financial resources directly to and from each other, without being connected to a Master Transfer Account 410.

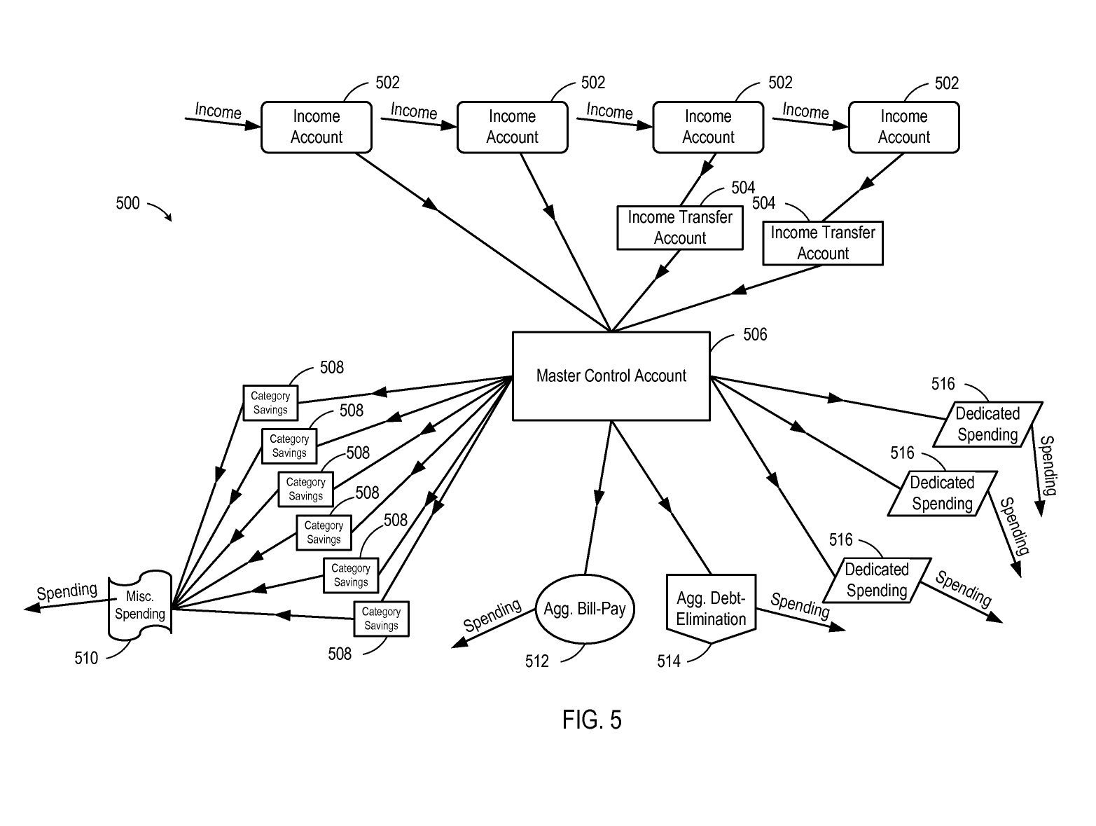

FIG. 5 shows an alternative account system 500. Similar to FIG. 4, the system 500 can include income accounts 502, category savings accounts 508, and a master control account 506. In addition, income transfer accounts 504 can transfer money between internal accounts. category savings accounts 508 can be internal accounts that are transferred to a miscellaneous spending account 510 when money within the category savings account 508 is to be spent. Dedicated spending accounts 516 can exist that allow money to flow from the master control account 506 into the dedicated spending accounts 516. An aggregated debt-elimination account 514 can take funds that were allocated to debts that are now paid off and use the funds to pay off other debts. An aggregated bill-pay account 512 can be used to receive money from the master control account 506 and pay reoccurring bills.

In an embodiment, income transfer accounts 504 are configured for the purpose of transferring money solely between internal accounts and for temporarily safely storing money until the user provides instructions for money to be transferred into another Account. Income transfer accounts 504 can also be used to facilitate and manage advanced transfers within The Money Pool System™ to effectively automatically handle the transferring of money between multiple different Accounts.

In one embodiment, the user can set up and configure a specific type of income transfer account 504 called a master transfer account. A master transfer account can be configured to receive the user's money from the income accounts 502. In this manner the user's money is channeled through a master transfer account where a series of automatic recurring transfers can be sent out to other Accounts owned by the user.

The embodiment can also allow for features for transferring money from one Account to another Account. Income transfer accounts 504 can facilitate advanced money transferring features from Account to Account. These advanced transfer features can include, but would not be limited to, the following abilities: select and edit multiple transfers simultaneously; create or import a template of a set of one-time or recurring transfers that can be automatically assigned to the appropriate Accounts by the account nickname, account identity, or account spending category(ies); simultaneously pause multiple scheduled transfers indefinitely or for one or a set number of occurrences; log into the computer processing system at a later date and recommence a specific transfer that has been suspended or group of suspended transfers; receive notification if there were insufficient funds to execute one or more transfers from an Account and have the computer processing system prompt the user to continue selecting individual transfers to temporarily suspend until the total amount for the scheduled transfers is lower than the total balance in the Account allowing the remaining transfers to be executed; run and view a report on past transfers that meet specific criteria; and/or perform automatic currency conversion and exchanges, including from type of money or currency, whether electronic, virtual, or other type.

Income transfer accounts 504 can allow the user to safely store money in an Account that provides protection against being compromised by fraudulent activity. Income Transfer Accounts 504 can also help facilitate multiple transfers, advanced transfers, and automatic transfers internally from one Account to another owned by the user.

In some embodiments, category savings accounts 508 can be functionally similar to regular bank savings accounts except that category savings accounts 508 can be configured to not be able to receive money from or send money to an external account, thereby acting as Safe Accounts. Also, category savings accounts 508 can be used to save money for one specific category of a user's financial matters. These planned events or predictable expenses can be but are not limited to items such as auto repairs, auto maintenance, home repairs, taxes, medical expenses, dental expenses, vacations, etc.

Proactively allocating and holding a user's money in separate Accounts, by spending or saving category, can help the user more accurately realize the opportunity cost associated with the spending of money for any purpose other than what the user had originally planned. For example, if the user has spent the amount of money initially allocated to the user's category savings account 508 set up and configured to cover personal clothing expenditures, in order to spend more money than was originally allocated on clothing, the user can be forced to re-allocate, or take the money from another Account that was set up and configured for a separate unrelated purpose. Because the purpose for which each category savings account 508 is intended to be used for is clearly labeled through descriptive names such as “Susan's Birthday Savings!” or “Europe Family Vacation 2015!” the user is forced to confront what he or she would be choosing to give up in order to spend money on clothing. This proactive knowledge and conscious choice helps the user experience the negative emotional consequences of the opportunity cost of each spending decision before and/or at the time it is made.

In one embodiment, a miscellaneous spending account 510 can be linked within the system with other accounts and configured to receive money for external spending. Purchases related to an expense that can logically originate from one of the user's category savings accounts, or any other Accounts, can be transferred from the specific Account to the miscellaneous spending account 510 in order to make an external payment transaction or spend the money. The user can also link a category savings account 508 or other type of Account to the miscellaneous spending account 510 so that at the point of sale enough money to fund a specific requested transaction can be automatically transferred from the category savings account 508 into the miscellaneous spending account 510 in order to fund the transaction. Miscellaneous spending accounts 510 can store little to no money, so if their account information was compromised, there can be little to no monetary losses due to fraud related to miscellaneous spending accounts 510.

By having a miscellaneous spending account 510 that money is easily transferred into for spending, the user is able to have multiple category savings accounts 508, or other Accounts configured to each be used for a specific purpose, without exposing each Account to external contact and without having to carry around a method of payment to spend directly out of each other Account.

A dedicated miscellaneous spending account 510 can help minimize losses related to certain types of fraud. In cases of fraud where the user's Account is compromised by his or her Account information being recorded by a skimming device at the point of sale or by the merchant's transaction records being compromised at a place of business where the user had completed a transaction, with the aforementioned system, very little to no money would be placed at risk of being stolen specifically because the compromised account information would not be for an Account where money is routinely stored for long periods of time, but rather an Account where enough money is transferred into the Account, in order to cover a specific transaction shortly before the transaction is to be executed.

In an automated debt payment embodiment, the system can be configured to allow for Accounts to be set up for specific purposes, such as paying off debt. These Accounts can be called automated debt payment accounts. These Accounts can also be configured to take advantage of existing or new account financial aggregation services to link directly to external debt accounts that the user may have. Using the information gathered from the account aggregation service, the system can be configured to pay off a group of debts, automatically deciding how much to pay to each debt using well-known debt reduction strategies. For example, an automated debt payment account set up and configured for the purpose of determining the best method of paying off a group of debts uses an account aggregation service to link directly to the user's existing loan or debt accounts to determine current, real-time information about the debt such as total current balance, interest rate, payment amount, and next payment due date. The computer processing system can then use this information, along with other user information, to automatically pay strategic amounts to each debt according to debt reduction strategies. One such strategy that the computer system might follow is known as a debt roll down strategy where the processing system can allow for the computer or the user to identify a debt as a Target Debt. Debts other than the Target Debt can receive the minimum required monthly payment. This account can also be called an aggregated debt-elimination account 514.

The Target Debt may be designated to receive enough money to cover the minimum payment plus any extra money allocated and transferred into an automated debt payment account that is not required to pay the monthly minimum payments on other debts. The Target Debt can be chosen by the user through user input, or automatically determined by the computer processing system based on debt reduction strategies such as choosing the debt with the highest interest rate or the lowest balance. In this manner the computer system can automatically assess, allocate, and/organize money that gets transferred into a specific Account and ensure that debt payments are made on time.

This can allow the user to be able to eliminate the element of human error involved with and automate the process of paying off debt in a strategic manner. This can also save the user from having to complete hours of tedious calculations trying to figure out the best way to pay off the user's debts.

In a spending facilitator embodiment, a processing system is configured to facilitate tracking spending to ensure that spending is properly categorized automatically, so that spending reports deliver accurate and meaningful data without having to rely on the user to record or track spending. This processing system can consist of a computer program or application that may exist on a personal computer, a tablet, a mobile device, the Internet, or any other type of electronic device. The processing system can provide a way for the user to designate a specific spending Account or a miscellaneous spending account as a default miscellaneous spending account to carry out all or some of the user's spending. The computer processing system can provide a way for the user to select or highlight any of the user's Accounts out of which he or she would like to initiate a spending transaction.

The program can then provide a way for the user to input how much money the user would like to spend from the selected Account. Once the Account and the amount to be spent from the Account have been confirmed, if no specific Account is chosen to be the Account that the money is to be transferred into in order to be spent for the transaction, then the money can automatically be transferred into the previously designated default miscellaneous spending account in order to be spent, thereby allowing the user to have to designate the Account that money is to be transferred into for spending one time instead of having to designate the Account for money to be transferred into for spending on each individual transaction.

In some embodiments, three reasons exist for the system to be designed and configured in this manner, which reasons include:

First, by having a single Account that money is easily transferred into for spending, the user is able to have multiple Accounts designed and configured to be used for a specific purpose, without having to carry around a method of payment to spend directly out of each Account.

Second, it helps minimize losses related to certain types of fraud due to the incorporation of Safe Account attributes and by limiting the exposure of each account by having the money diversified across many accounts.

Third, it allows for an automated spending tracking system to be capable of more accurately tracking user spending. Instead of an automatic spending tracking system to have to estimate what category to assign each expense, the system can simply assign each expense to a spending category based off which Account it originated from.

In one embodiment, the computer processing system also provides a method for handling certain transactions such as the transferring of money from an Account into a designated miscellaneous spending account, in order to fund transactions for which there is not enough money to fully cover the transaction, solely from the specific Account from which the specific type of expenditure should logically originate. If the user desires to make a purchase from an Account without enough money in the Account to cover the transaction, regardless of whether the user wishes to spend directly out of the Account or have enough money transferred into a designated miscellaneous spending account to fund the transaction, the user can select the Account the user wishes to spend out of and input the amount to be spent.

In the event that there is not enough money in the selected Account to complete the transaction, the computer can prompt the user to choose another Account from which to withdraw the additional money needed in order to make up the difference and fund the transaction. Knowing the Account that the user originally selected as the Account that the user wishes the transaction to originate from, without the user having to record anything or make any notations, the computer processing system automatically makes the necessary notations to ensure the money taken out of the secondary Account(s) is recorded correctly, and shows up in reports, as though the transaction was for expenditures related to the purposes linked to the Account of origination.

For example, the user chooses to spend out of the user's Account set up and configured for covering expenses related to clothing. The user selects the Clothing Account and inputs into the computer $100 as the amount to be spent. The user currently has $15 in the Clothing Account. The computer can then prompt the user to designate another Account or Accounts from which to withdraw the additional $85 needed to fund the transaction. The user may then decide to select a Birthday Account or any other Account to withdraw the money needed in order to fund the transaction. In this manner, without the user having to manually record and/or notate that the $85 withdrawn out of the Birthday Account was actually spent on clothing, the computer can automatically make those notations and maintain accuracy and integrity in the financial reports.

In one embodiment, the Account that the user designated as the miscellaneous spending account may not store money but can be used to facilitate payments from other Accounts. If the user wishes to spend out of a specific Account that does not have a method of payment desirable to the user attached to it, then the user may select the Account that he or she would like the transaction to appear to have originated from as a backup Account to the miscellaneous spending account. Backup Accounts can be set up and configured to be in effect for a certain number of transactions, for a certain period of time, or until instructed otherwise by the user. Backup Accounts can also be set up and configured to be used up to a specific dollar amount.

For example: A user wants to buy an article of clothing. The user does not know exactly how much it would cost so he or she designates the Clothing Account to be a backup Account to the miscellaneous spending account for the period of a single transaction. Since the miscellaneous spending account does not have money stored in it, when the user completes the transaction from the miscellaneous spending account he or she can deduct the entire amount of the transaction from the Clothing Account. If there is not enough money in the Clothing Account to fund the transaction then the transaction can be declined or alternately the user can designate another Account as a secondary backup Account. Secondary backup Accounts can also be configured to be in effect for a certain number of transactions, for a certain period of time, for a certain dollar amount, or until the user directs otherwise.

In this manner, backup Accounts can continue to be applied in succession so that an Account can be a backup Account and if there are insufficient funds to complete the transaction, another Account can be a secondary backup Account. If there are still insufficient funds to complete the transaction in both Accounts combined then another Account can be the third backup Account and so forth. Backup Accounts, secondary backup Accounts, and so forth can be chosen manually by the user or be automatically selected based on criteria such as the order of importance that the user has designated to each Account. For example: If this feature was turned on, and there is not enough money in the Account that the user has selected as the backup Account to the miscellaneous spending account, then the secondary backup Account can automatically be the Account that the user designated as lowest priority. The Account the user designated as second lowest priority can be the third level of backup Account and so forth.

Because each of these alternative methods starts with the user selecting an Account or Accounts of origination, the computer system can maintain the integrity of reporting so that the expense is recorded to be an expense related to spending out of the Account of origin(s).

In one embodiment, the computer processing system allows for specific Accounts to be linked to an electronic debit card (electronic debit card: a debit card in which multiple cards can be stored; the electronic debit card has the look, feel, and approximate dimensions of a regular debit card but is electronic and can have the information for several different cards programmed onto it so one can toggle through a screen on the card to choose which Account the card can be linked to) that can have the same aforementioned features, such as the user being able to choose and alternate between different Accounts designated as backup Account(s).

In one embodiment the computer processing system allows for a specific Account to be linked to a virtual miscellaneous spending account(s) on an electronic device such as a mobile phone or tablet.

In one embodiment The Money Pool System™ can be set up, configured, and implemented where some or all Accounts can be one of the various types of card network, or other card type accounts. These types of accounts include, but are not limited to, prepaid debit cards, gift cards, credit cards, and/or prepaid credit cards.

In one embodiment, the user can view an accounting of money withdrawn from backup Accounts for the purpose of helping to fund transactions that should have been fully funded out of another Account. The user can then have the opportunity to pay back the Accounts from which money was taken. The user can choose to pay back the money from the Account that received the extra money or from any other Account. The money to pay back the Account can be taken out all at once, at a later specified date, or over time by rerouting a percentage of the user's weekly transfer from another Account or Accounts, until the amount that was taken is paid back. For example: The user may be able to view a list of transactions where money was taken from Accounts in order to fund transactions for purposes other than what was originally intended for the Account. The user may find a transaction for $85 that was taken out of a Birthday Account in order to help fund a clothing expense. The user may decide to reroute 20% of the weekly transfers to the Clothing Account each week to go to the Birthday Account until the $85 is paid back. The user can also choose to reroute 5% out of seven other unrelated Accounts to go to the Birthday Account until it is paid back.

The user can find it quick and easy to follow this procedure when making purchases that he or she may be more likely to continue to receive the benefits of using The Money Pool System™ such as being able to spend less money than he or she earns and enabling the user to save up for meaningful financial goals. Without the user having to follow the cumbersome steps necessary to manually record and track spending, this embodiment makes it possible to automatically generate accurate spending reports by category for any designated period of time such as a month, a quarter, a year, or a series of years.

In an embodiment, a Behavioral Management Processing System establishes an emotional attachment to the Accounts and default effective financial management actions.

The Accounts can be configured to associate or to attach items to each Account to establish or help the user develop an emotional attachment to the purpose for which the money is to be allocated and later spent. These items associated with or attached to each Account can be a plurality of items such as, but not limited to: strategic customized names, identities, codes, biometric data, photos, music, emoji, background themes, descriptions, profile data, motivational quotes, goals, calendar events, e-cards, virtual pets, and/or other items that can evoke an emotional connection with the user to the purpose for which the money deposited into the Account is supposed to be spent.

For example: A user might have an Account configured to associate or attach a picture or homemade video clip of the user's spouse; the Account might be named Susan's Birthday Party! Upon viewing the Account, a clip of Susan's favorite song can start playing. The Account can also have a background with birthday cakes and presents in view. The Account can also have a motivational quote about birthdays. The Account might also be linked to a calendar with Susan's Birthday marked. The Account can also have an alert or reminder scheduled to remind the user when the user's birthday is approaching.

By becoming more emotionally attached to the purpose for which money is allocated, the user can experience the emotional consequences associated with the opportunity cost of spending money out of an Account for a purpose for which the Account is not designed to cover, before the user actually spends the money, thereby allowing the user to make better financial decisions.

The Behavioral Management Processing System can recommend and/or automatically implement default effective financial management actions to help the user better manage his or her financial matters and/or achieve his or her financial objectives. Default actions can include actions such as automatically allocating a pre-determined savings amount for desired savings goals, etc.

In a setup wizard embodiment a computer processing system is configured for automatically setting up and configuring the various aspects of The Money Pool System™ or other embodiments of a proactive electronic resource allocation processing system. This Configuration Processing System can provide a survey or series of surveys for a user to answer a series of questions about the user's personal information, including things such as personal and financial personality, profile, history, status, family situation, career stage and development, goals, and priorities, among others. The survey can be carried out in the form of a face-to-face oral interview, in written form, or on a computer or other electronic device. The objective of the survey is to gather and determine specific important facts about the user's personal financial situation and financial goals.

The answers that the user provides to the survey(s) are then used by the Configuration Processing System to give the user financial advice and/or recommendations as to what actions are recommended in order to move forward toward reaching the user's financial goals. In an embodiment, the answers may be analyzed either wholly or in part by a person.

These recommendations are delivered to the user, for the user to edit and review, in the form of i) a face-to-face oral interview, ii) in written form through a financial report or other financial document(s), or iii) on a computer or other electronic device.

The recommendations generated by the processing system from the results of the user survey(s) can be based solely or in part on information gathered in the survey(s), or be based solely or in part by statistical or benchmark data averages of people with similar financial profiles, demographics, and/or situations compared to the user's financial situation or based on the discretion of the financial institution.

One embodiment includes a processing system for accessing, importing, and analyzing data about the user's personal finances and/or past spending for analysis, for the same aforementioned purposes, from an aggregation service (as described below), an existing Personal Finance Management (PFM) system, an online and/or offline budgeting system on a computer or other electronic device, and/or a written form of a budget. This information can be transferred either manually or through a computer processing system that translates and transfers the data and/or through aggregation from one system to another.

An embodiment includes a method for offering the user a general template of recommended Accounts that the user might want to utilize to quickly set up and configure to start running The Money Pool System™. This template can be provided to users that are impaired, disabled, or for any other reason are unable or unwilling to complete a survey to develop more personalized suggestions. The general template of Accounts would not be as personalized as recommended Accounts generated from the more desirable aforementioned methods of the user completing The Money Pool System™ Setup Wizard or the aforementioned method of importing the user's past aggregated spending information and data for analysis, but the general template(s) can still include recommendations that are vastly superior to the ones offered to users by current financial institutions.

For example: With The Money Pool System™ a user can be offered a template of Accounts with names such as Grocery Money, Entertainment Money, Christmas Savings, Vacation Savings, etc. The templates can also have or be linked to commonly available or personalized and customized pictures and/or music, background themes, motivational sayings, and/or other items commonly or otherwise associated with these types of spending categories to be attached to each Account so as to foster an emotional connection between the user and the money to be allocated to and spent in the Account. The user can also be offered suggested amounts to allocate to each Account, how often the Accounts should be funded, and from what sources, whether from external deposits directly to the Accounts or internal transfers from one or more existing Accounts. These suggestions can be based on benchmark data or discretion.

Once the recommendations have been delivered to the user for review and edit, the system has the ability to receive authorization from the user to automatically execute the series of steps to configure and implement the strategies and/or other recommendations.

The recommended Accounts, funding parameters, automatic transfers, and other recommendations can be automatically set up, configured, and optimized in order to save the user significant time and greatly increase the chances of the user setting up and benefiting from his or her use of The Money Pool System™.

In one embodiment, a configuration wizard is presented in the form of a survey to help users quickly and easily set up and configure a personalized version of The Money Pool System™ or variant of The Money Pool System™, including the specific or recommended categories of spending Accounts, and the specific or recommended dollar amounts of periodic allocation and transfers into each spending or other Account.

In addition to the embodiment of the configuration wizard as described, this embodiment also has two alternative systems and/or methods to help users quickly set up and configure The Money Pool System™. One of these systems includes a computer processing system that can import, translate, and analyze data about the user's personal profile, demographics, and finances from PFMs and/or other software or budgeting systems, and use the gathered data to design a personalized and customized version of The Money Pool System™ for the user. The second alternative method of helping a user set up and configure The Money Pool System™ is to provide the user with a pre-determined, recommended template of The Money Pool System™ based off of benchmark data and/or the financial institution's discretion of the most effective way to set up and configure a generic version of The Money Pool System™.

Once The Money Pool System™ has been designed and personalized to the user's situation according to one or more of the three aforementioned methods, the proposed personalized version of The Money Pool System™ is delivered to the user for edit and review. After the user has made any desired edits and/or changes, the user can then manually set up and configure The Money Pool System™ or give authorization for the processing system to automatically set up and configure The Money Pool System™ at an authorized licensed financial institution.

Facts about the user's personal financial situation and financial goals can include information such as but not limited to: profile information for the user and immediate family members, including name, address, contact information, age, birthdays, hobbies, education and career goals, recurring life events like travel or family reunions, bank account information, investment account information, various insurance information, etc.; spending and saving categories the user has previously allocated money to or spent money in and how much, and how frequently the user has spent in these areas in the past; spending and savings categories the user thinks he or she will likely be spending money in going forward into the future; what spending and savings categories are most important and least important to the user; current and future projected income (recurring, variable, one time); employment profile including work location, position, and salary; current and future projected debts and liabilities; current and future projected investments and assets; planned, projected, predicted, and unpredictable events and expenses; goals for retirement and financial freedom; financial strengths and weaknesses; and/or risk tolerance or aversion as it pertains to savings and investments and other personal financial matters.

Specific financial advice and support for the advice might include, but would not be limited to:
1) Type and number of Accounts the user might want to set up and configure.
2) Specific categories or areas of spending or savings that each Account should be limited to being used for.
3) Strategic items that can be attached to, or associated with, each Account in order to help the user establish an emotional connection between the user and the purpose for which the allocated money in the Account should be used. Examples of such are:
   a) Personalized account name
   b) Additional nickname for Account to establish or foster an emotional connection, like the name of a pet or child
   c) Avatar for Account
   d) Music, or other sounds, including voice recordings to express positive or negative emotion depending on action (i.e., happy sounds upon deposits, and sad or painful sounds upon spending, etc.)
   e) Pictures of the physical “cash” currency or bills that would comprise the money in the Account, to make it feel “real” in terms the user can relate to; photos of current possessions, including clothes, which often help a user realize how much he or she already has and can help reduce feelings of want for additional items; handmade drawings; or other photos
   f) Video clips
   g) Emoji
   h) Descriptions and lists, including:
      (1) Goals associated with the Account
      (2) Motivational quotes
      (3) Rewards for goal achievement
      (4) List of life priorities that do not require spending money
      (5) List of things the user enjoys other than shopping or spending money
      (6) List of other things the user can accomplish without spending money (gifts, entertainment, etc.)
      (7) List of needs versus wants
   i) Virtual pet
      (1) Including concepts common to virtual pet programs. For example, the pet grows or provides positive feedback when it is fed, where feeding can be associated with deposits to the Account, or progress toward a savings goal.
   j) Virtual rewards for goal or spending achievement like tokens, stickers, badges, etc.
   k) Background design themes for each Account
   l) Status and progress reports or updates
      i) List of other people who have access to view or receive updates
      ii) Linked to private or public online sites with social sharing of results and/or progress
      iii) Graphics and charts reflecting progress in general, or toward specific goals or targets
      iv) System wide “brag board”
   m) Other reporting:
      i) Hours worked to earn and save dollars accumulated in the Account
      ii) Hours worked for each dollar spent from the Account
      iii) Impact on retirement date or debt-free date goal of each dollar spent from the Account
4) Other strategic items that can or should be attached to, or associated with, each Account in order to help the user control and manage funds in the Account, and save more or limit spending to the desired level
   a) Debt owed to Account (money to be repaid to an Account based off of money borrowed from it to pay for a transaction for items that were outside of the scope of spending intended for the Account)
   b) Reminders, notification, and alerts (manually entered reminders, which can be in the form of various items, including motivational quotes)
   c) Lists
   d) Shopping list/cart (particularly for shared Accounts)
   e) List of items to avoid buying
   f) Other notes:
   g) Calendar events noting upcoming dates and events that will require purchases like birthdays, etc., and noting major spending events from previous years
   h) Public and private access links
      i) Allowing for other friends, family, etc. to contribute to the funding of the Account
      ii) Allow for a community to create a common account for funding various purposes, such as community charity or other fundraiser projects, building projects, etc.
      iii) Allow for gifting to the Account similar to a bridal registry
      iv) Allowing for other friends, family, etc. to post digital media to the Account to offer encouragement, etc.
      v) Allow vendors to post offers, coupons, discounts, etc. to the Account
      vi) Shopping cart, visible to vendors, which can submit bids or offers on future purchases
      vii) Other loyalty cards and rewards programs
   i) Additional embodiments can include:
      i) Account can be provided its own digital “identity” and digital contact address for purposes of interacting with the Account
      ii) Digital identities can enable advanced functionality, such as
         (1) electronic and crypto currency payment and transfer capabilities
         (2) current and future sensor, alert, notification, beacon, and other digital interactions with the Account
5) Advanced configuration rules for each Account can include:
   a) Restrictions and limitations on the Account and amount available to spend based on time, location, other context, and/or environment or personal bio beacon or sensor feedback (for example Account may be locked if presence of alcohol is detected)
   b) Reminders, notifications, etc. for each Account to the Account owner, or to others, of spending activity and behaviors
   c) Links to video cams and/or other sensors that indicate the inventory status or other condition of frequently purchased items
   d) How often and how much money should be allocated and transferred to each Account so that each Account is properly funded
      i) What spending category(s) and associated spending Account(s) should be considered high, medium, low, and/or lowest priority
      ii) What spending category(s) the user should increase or decrease funding to over time based on the user's financial strengths and/or weaknesses, goals, and/or other external factors
      iii) Configuration rules for each Account
      iv) Investment or savings advice based on the user's risk tolerance/aversion and based on the user's financial strengths and/or weaknesses, goals, and/or other external factors
      v) Recommended financial courses or trainings based on the user's financial strengths and/or weaknesses, goals, and/or other external factors
      vi) Recommended financial strategies or programs based on the user's financial strengths and/or weaknesses, goals, and/or other external factors
      vii) Recommendations for level of security, authorization, and authentication that should be associated with each Account
      viii) Single person or joint control and authorization
      ix) Single- or multi-factor authentication required
      x) Recommendations for changes to current service providers such as insurance carriers or lenders
      xi) Other money-saving recommendations such as moving closer to work, eating out less, or riding a bike to work

Steps to configure and implement the strategies and/or other recommendations can be performed by the system described above, such as shown in FIG. 1. A representative, employee, or affiliate of a financial institution or a computer processing system automatically sets up the recommended necessary Account(s) complete with recommended names and/or automatically completes the enrollment process for other recommended programs and services. These recommendations can be automatically executed at a single specific financial institution(s), affiliate company(s), organization(s), and/or with an outside, unrelated, or unaffiliated company(s) and/or organization(s). The system can schedule the recommended automatic recurring transfers, automatic bill pay services for debts, and/or regular monthly recurring bills. The system can set up and configure automatic alerts and/or scheduled future changes to the financial plan, strategy, and/or other recommendation(s). The system can give the user a report of the steps, procedures, and/or tasks that have been automatically executed.

An Active Agent (“AA”) can include a computer processing system that actively searches, locates, monitors, and gathers the latest updates to both internal user data and externally available information, and automatically incorporates that collective original and updated information in active and ongoing analysis and assessment of a users' financial situation and behavior, including allocation of a user's financial resources. The AA dynamically analyzes, assesses, determines, and makes recommendations for user acceptance or approval. In some embodiments, the AA may be configured to make changes directly to a user's Configuration Information or other financial matters, including regarding periodic allocations of resources to Accounts, without first obtaining user acceptance or approval. The AA can be configured to interface with other internal or external processing systems to actively search, locate, monitor, gather, determine, and make recommendations and, in some embodiments, directly make changes or allocations to Accounts. External processing systems can include ACH, direct deposit or other payroll or income sources, bank or other financial institution accounts and systems, etc. Internal processing systems can include, for instance, the user Interface, the Data Store, the Behavior Management Processing System, the automated proactive resource allocation processing system, etc.

The AA processing system can monitor, gather, and incorporate real-time, updated knowledge of internal user data, including the following, affecting a user's financial matters:
1) Income flows
   a) Pay periods
   b) Regularity of pay amounts
2) Debt information:
   a) Interest rates
   b) Minimum monthly payment amounts
   c) Payment and payoff dates
3) Bill payment information
4) Recurring expenses
5) Anticipated, planned and predictable expenses
6) user's profile information
7) Personal and family goals and priorities

The AA processing system can also search, locate, monitor, gather, and incorporate real-time, updated knowledge of externally available information, and make recommendations concerning a user's financial matters, such as, but not limited to, the following:
1) Current best rates on mortgages and other credit
2) Savings and investment rates and prices
3) Current best prices of goods and other services frequently purchased by a user
4) Forecasted prices of goods and services frequently purchased by a user
5) Discounts, sales, and offers of goods and services that may be of interest to a user, or that a user may have planned to purchase
6) Benchmarks and statistics

Having the implicit (or explicit, as may be required by any applicable laws or regulations) consent of users to actively monitor, gather, process, and store information for the user gives the AA a significant advantage for helping a user manage his or her financial matters, including optimizing the allocation of the user's financial resources. As the AA assists users in more effectively managing how users allocate and spend their money, the AA gains first-hand knowledge and insight of a user's spending patterns and behaviors. This knowledge and insight includes how, when, where, and why users do in fact spend their money, as well as, among other things, the configuration rules and other information associated with those allocations and spending transactions. This information is processed and stored to allow the AA to make more intelligent recommendations.

Over time, the AA becomes smarter and smarter about the user, the user's activities, and the user's behavior. Through access to and monitoring the various processing systems of The Money Pool System™, the AA is gathering up-to-the moment information about the financial transactions and services an individual engages in as part of the user's everyday life, the context in which they occur, and aspects of the user's behavior. The AA can collect daily statistics about financial transactions of the user, the amount of income and expenses by category, what the user actually purchases, the timing and method of purchases, other financial habits, etc.

user acceptance, participation in, and implementation of The Money Pool System™, and/or other embodiments, is significantly enhanced by the ability of the system to start with a simple model and to learn and improve over time, making and incorporating recommendations for improvement based on the learned financial transaction patterns, behaviors, and other profile information of the user.

As users implement The Money Pool System™, or other embodiments, and delegate mundane, as well as more complex computational, aspects of their financial matters to the The Money Pool System™, the AA can provide a growing knowledge base of information about individual user financial transaction patterns and behaviors, and about the financial transaction patterns and behaviors of the community of users. This information gives power to the AA to provide dynamic feedback and reporting to the user, as well as to develop strategies and recommendations that benefit the individual user, as well as the community of users. Although use of the information is individualized and private, the meta data about collective financial transaction patterns and behaviors can be utilized to provide anonymous benchmarks and other helpful financial and behavioral data and recommendations back to the individual users. In one embodiment, data gathered by the AA can be made available to external parties through an application programming interface (API) for purposes such as offering discounts to the individual or community of users, among other purposes.

In an aggregation service embodiment, the user is provided with an aggregation service where the user can access and view their account information with one, many, or all of the user's Accounts at various financial institutions in one place with one login. The user can grant permission to the bank or other financial institution or third-party service provider to have access to the aggregated data. The bank customer service personnel and computer processing systems can monitor and compare the user aggregated data against all available data in the market for services, rates, offers, coupons, etc. that might be of interest and/or of value to the user. A financial institution can benefit from the use of this system as it identifies lending opportunities based on the terms of existing debts to provide only the most relevant offers to the user. A financial institution can more effectively manage risk by not lending to users who might have good credit scores, but lack the cash flow necessary to repay the loan. A financial institution can have substantially lower loan origination costs because it will not have to pay loan officers to originate loans as the bank's computer processing system can potentially originate the loan applications and/or the loans.

The user will benefit by receiving pre-approved offers for financial services that are customized to the user's needs and goals and only when there is a real benefit to the user. For example, the user can potentially receive offers for lowering his or her interest rates, when the system detects that lending criteria are met. The user saves time by eliminating the need to shop and search for these opportunities, and by using streamlined application processes. The user may simply click on the pre-approved offers to accept them as they are presented.

Due to this shared data relationship, the bank can also offer “smart” bill-pay services that always have up to-date information on the user's debts such as minimum payments, interest rates, and balances.

In an asynchronous account update embodiment, users of The Money Pool System™ can view their current available Account balance within an application on a smartphone or other device before making a spending decision. However, if the user is in an area where the device has no Internet connection, the balance information displayed might not be accurate, as it might not include the most recent updates. In such a case with this system, the balance shown on the device will be grayed out with the notation “click to update” displayed. When the user clicks on the notation, the mobile device sends a text message (e.g., SMS message) to the bank or financial institution where the Account is linked and receives a return text message with the current balance and automatically updates the balance on the device with a date and time stamp.

This embodiment can be applied to a plurality of businesses, entities, or other organizations, including banks, other financial institutions, or any other business offering financial services. In one embodiment (or, as one example of how this might be implemented) this innovation can be used in conjunction with a bank and bank-offered services.

The user will be able to see the current available balance of any Account on a smartphone or other device, even when no Internet connection is available, provided that text messaging service is available.

In a dynamic account selection embodiment, a debit card, or other payment card or device, can dynamically change the funding source for a payment (i.e., each purchase, time based, etc.). A payment card, or other payment device, can serve to access a plurality of accounts from the bank or other payment entity that issues it. An application on a smartphone (or other device) lets the user see and/or change which account the payment card or device is accessing, along with its balance, by clicking on it. In the case of failure to connect due to a poor or no Internet connection, account selection can be greyed out, allowing the user to click to update it with the proper account and balance by automatic text communication with the bank as previously mentioned.

In one embodiment, a user can carry multiple debit or payment cards, for example up to 30 or more, with each card being used to access a separate Account. In another embodiment, a single payment card can access multiple Accounts owned by a user at one bank but at no other financial institution. A software application on a smartphone lets the user select which account the card is accessing while viewing its balance. In another embodiment, the application, or smart card, can be configured to recommend a spending account or funding source based on various data or configurations, including account owner, account identity, location, or other context data available to the smartphone from sensors or user input, etc. The user can be presented with options to confirm or override the recommendation.

In the case of a failure to connect to a particular bank or other account provider due to a poor Internet connection, the application generates an automatic text to the bank triggering a return text to confirm to the smartphone which account the user is connected to so it can be properly displayed on the smartphone. It can intelligently select a default account that it thinks a user will want to use based on several factors such as recent spending patterns, time of day, or geo tracking of current location.

The user will be able to easily access any Account at the issuing bank or other entity and see which Account is being accessed and the current available balance of that Account. Because the user no longer needs to carry multiple payment cards, the user is now even more likely to manage his or her finances within the financial plan that he or she has designed and committed to.

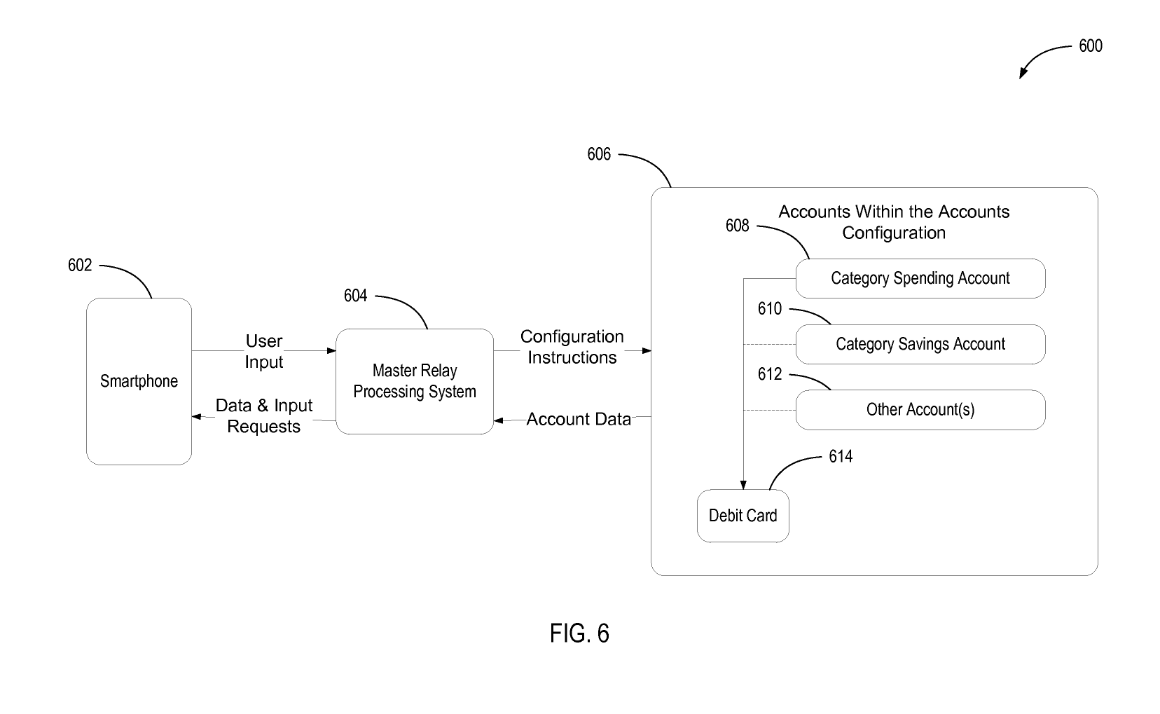

FIG. 6 illustrates how in one embodiment, a user can dynamically select and/or change the funding source linked to the user's debit card 614 or other payment device. In this manner, a single payment card, or other payment device, can serve to access a plurality of Accounts contained within the user's Accounts Configuration 606. On the user's smartphone 602 or other device, the user selects an Account out of which the user desires to spend or make a payment. The selection decision is captured by the processing system on the smartphone or other device as user Input, which then is relayed to the user's Accounts Configuration 606 and the specific Accounts impacted through the Master Relay Processing System 604. The impacted user Accounts are reconfigured so that the user's debit card 602 is linked to the Account that the user selected for spending. The accounts can be a category spending account 608, a category savings account 610, or another account 612. The master relay processing system and accounts within the accounts configuration can be composed of one or more servers, databases, or other computing resources.

In an embodiment, the Account out of which to spend can be automatically selected by one of the Master Relay Processing System 604, the Active Agent Processing System, or another processing system running either locally on the mobile device or on a connected server. The Account selection processing system can be configured to take into consideration a plurality of factors obtained from the smartphone or other device, including location, other context information, beacon or sensor information, etc. In an embodiment, the Account selection made by the processing system is first presented to the user as a recommendation for the user to confirm and/or authorize prior to Configuration Instructions being sent to link the debit card, or other payment device, to the selected Account. The computer processing systems and Accounts can be configured to provide the user with Account Data and various other information, including current available balance information of one or more Accounts, prior to the user making or confirming the Account selection. The Account selection processing system can be configured to consider a plurality of rules, restrictions, limitations, permissions, and/or attributes associated with the Account and/or the payment device prior to Configuration Instructions being sent to link the payment device with the selected Account. In an embodiment, the processing system can be configured to “remember” prior decisions based on location or other factors and apply that Account selection to the current and future transactions when the same criteria are met. In an embodiment, the dynamic account selection process can also be configured to function as described above for refunds and/or other credits to an Account that are made through a debit card or other payment device.

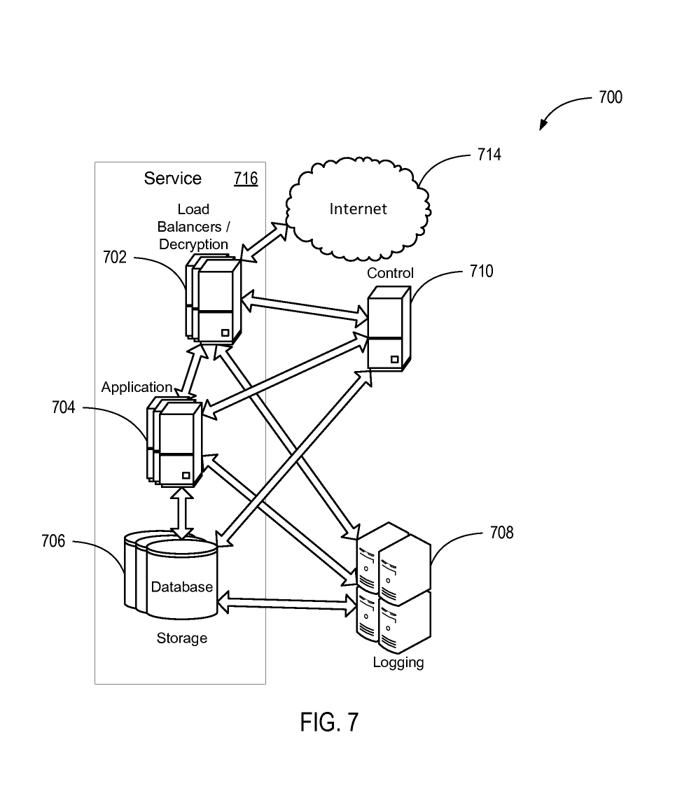

FIG. 7 is a system diagram illustrating a system 700 configured to provide services to a user consistent with embodiments disclosed herein. A user system (e.g., smartphone, laptop, etc.) can communicate with a service 716 over the Internet 714 as described above. An account service 716 (e.g., part or all of The Money Pool System™ or other systems or services described above) can include load balancers 702 capable of decryption, application servers 704, storage such as database servers 706, control servers 710, and/or logging servers 708. The load balancers 702 can receive requests from user systems and format the requests to be received by the application servers 704. The application servers 704 can receive data from the user systems and cause data to be stored by the database servers 706. The application servers 704 can provide results (such as account configurations, reports, status, etc.) to the load balancers 702, which transmit the results to the user system. The database servers 706 can store data regarding the financial accounts, configurations, and/or user account information. A control server 710 can monitor systems of the service 716 and/or cause servers to be added to pools of servers (such as the load balancers 702, the application servers 704, and/or database servers 706). The control server 710 can also provide data integrity/redundancy services such as causing snapshotting, caching, and/or other features. A logging service 708 can track usage and operations performed by the service 716 and on behalf of the service.

In one example, a user can set up an account with the service 716 using an application on a mobile device. The user registers an account with the service 716. The service 716 can store user credentials in the database server 706.

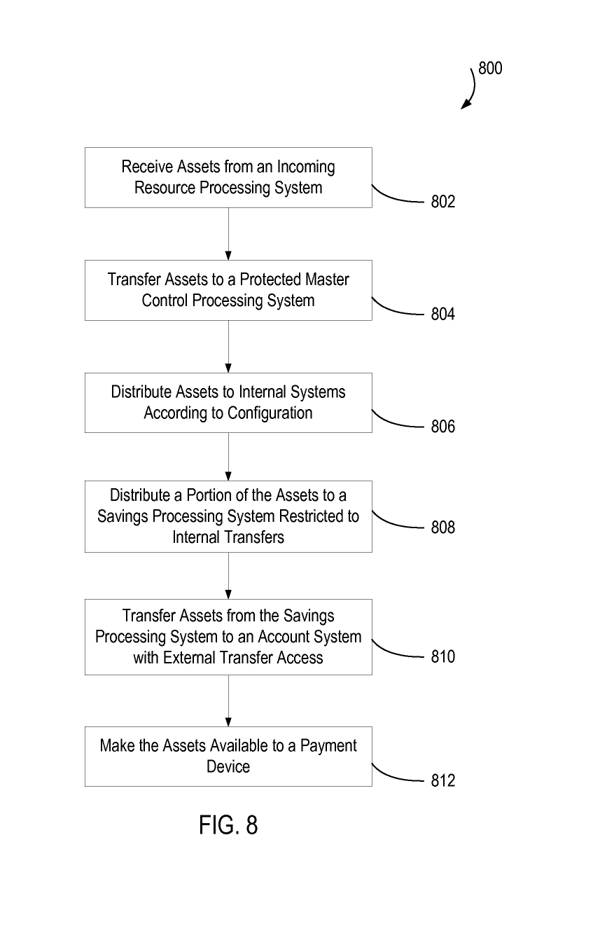

FIG. 8 is a flow chart that illustrates a method 800 for proactive electronic resource allocation. The method 800 can be implemented by a system such as shown in FIGS. 1, 4, and/or 5. In block 802, an income account system receives assets from an incoming resource processing system, such as a direct deposit. In block 804, the income account system transfers the assets to a protected master control processing system, such as a system that provides a master transfer account service. In block 806, the assets are distributed to internal systems according to a configuration, such as distribution to savings and spending accounts. In block 808, a portion of the assets are distributed to a savings processing system, such as a system supporting a category savings account, that are restricted to internal transfers. In block 810, some or all assets from the savings processing system are transferred to an account system, such as a system supporting a miscellaneous spending account, that allows external asset transfers. In block 812, the assets are made available to a payment device, such as linking a debit card to the miscellaneous spending account.

FIG. 900 is a schematic diagram of a computing system 900 consistent with embodiments disclosed herein. The computing system 900 can be viewed as an information passing bus that connects various components. In the embodiment shown, the computing system 900 includes a processor 902 having logic 902 for processing instructions. Instructions can be stored in and/or retrieved from memory 906 and a storage device 908 that includes a computer-readable storage medium. Instructions and/or data can arrive from a network interface 910 that can include wired 914 or wireless 912 capabilities. Instructions and/or data can also come from an I/O interface 916 that can include such things as expansion cards, secondary buses (e.g., USB, etc.), devices, etc. A user can interact with the computing system 900 though user interface devices 918 and a rendering system 904 that allows the computer to receive and provide feedback to the user.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smartphone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a nontransitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. One or more programs that may implement or utilize the various techniques described herein may use an API, reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general-purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and/organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” or “for example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

It should be recognized that the systems described herein include descriptions of specific embodiments. These embodiments can be combined into single systems, partially combined into other systems, split into multiple systems, or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. An automated electronic resource allocation system comprising:
an incoming resource processing system configured to receive assets from an external source and transfer assets to an internal system;
a master control processing system configured to receive assets from the incoming resource processing system and distribute the assets to internal systems according to a configuration;
a savings processing system configured to receive assets from the master control processing system, store the assets until a request to transfer the assets is received, and be restricted to an internal transfer of assets; and
a spending system configured to receive assets from the savings processing system or the master control processing system and to make available received assets for use with a payment device,
wherein the payment device is configured to transfer assets to an external system.

2. The system of claim 1, wherein the payment device is a debit card.

3. The system of claim 1, further comprising a spending processing system configured to receive assets from the master control processing system and make available received assets for external transfer.

4. The system of claim 1, further comprising an automated debt payment system configured to receive assets from the master control processing system and transfer the assets for payment of debts.

5. The system of claim 1, further comprising an automated bill payment system configured to receive assets from the master control processing system and transfer the assets for payment of bills.

6. The system of claim 1, further comprising a setup system configured for
receiving user input to a set of questions;
constructing a profile of the user based at least in part on the questions; and
providing a recommended set of transfer restrictions, transfer schedule, and transfer amounts based at least in part on the profile.

7. An automated electronic resource allocation system comprising:
an account management system configured for receiving, holding, and transferring of financial resources based on configuration information;
a behavioral management system configured for modifying configuration information based at least in part on user interaction with the account management system;
a configuration processing system configured for creating, modifying, and/or updating configuration information based at least in part on user input; and
an allocation processing system configured for allocating financial resources to a plurality of accounts.

8. The automated electronic resource allocation system of claim 7, further comprising an active agent system configured for monitoring user transactions and modifying the configuration information based on the monitored user transactions.

9. The active agent system of claim 8, wherein the active agent system further comprises an account management system interface configured to transmit requests to create new accounts based at least in part on the monitored user transactions.

10. The automated electronic resource allocation system of claim 7, further comprising a payment processing system configured for receiving a selection of an account selection and causing future payments to be applied against the account.

11. The automated electronic resource allocation system of claim 7, further comprising a setup system configured for receiving user input to a set of questions; constructing a profile of the user based at least in part on the questions; and providing a recommended set of transfer restrictions, transfer schedule, and transfer amounts based at least in part on the profile.

12. A method of allocating resources comprising:
receiving assets from an incoming resource processing system enabled to receive external assets and restricted to internal system asset transfers;
transferring assets to a master control processing system that is restricted to internal system asset transfers and internal system asset receipts;
distributing assets from the master control processing system to other systems based at least in part on a configuration,
wherein, at least a portion of the assets distributed to a savings processing system is restricted to internal system asset transfers and internal system asset receipts;
transferring assets from the savings processing system to an asset system with external asset transfer access; and
configuring the asset system with asset transfer access to link with a payment device.

13. The method of claim 12, wherein the payment device is a debit card.

14. The method of claim 12, further comprising constructing the configuration based at least in part on input from a setup wizard.

15. The method of claim 14, wherein constructing the configuration further comprises:
receiving user input to a set of questions;
constructing a profile of the user based at least in part on the questions; and
providing a recommended configuration based at least in part on the profile.

16. The method of claim 15, wherein the configuration is further comprised of one or more of category savings accounts, an allocation schedule to a category savings account, or an allocation amount to a category savings account.

17. The method of claim 15, further comprising:
creating a set of bank accounts based at least in part on the profile;
creating a set of transfer restrictions to the set of bank accounts based at least in part on the profile; and
configuring a set of recurring transfers between a subset of the set of bank accounts.

18. The method of claim 17, further comprising providing an account nickname for at least one of the set of bank accounts based at least in part on the profile.
